(19) United States
(12) Patent Application Publication
(10) Pub. No.: US 2024/0332771 A1
(43) Pub. Date: Oct. 3, 2024

(54) TUNABLE CAVITY FILTER

(71) Applicant: BAE SYSTEMS Information and Electronic Systems Integration Inc., Nashua, NH (US)

(72) Inventors: Mark D. Hickle, Merrimack, NH (US); Gregory M. Flewelling, Freeport, ME (US); Kim Eilert, Mesa, AZ (US)

(73) Assignee: BAE SYSTEMS Information and Electronic Systems Integration Inc., Nashua, NH (US)

(21) Appl. No.: 18/130,077

(22) Filed: Apr. 3, 2023

(51) Int. Cl. H01P 1/208; H01P 1/205; H01P 7/08

(52) U.S. Cl. CPC H01P 1/2084; H01P 1/2053; H01P 7/088

(57) ABSTRACT

An apparatus includes a lower plate, an upper plate above the lower plate, and a plurality of vias extending from the lower plate to the upper plate. The lower plate, the upper plate, and the plurality of vias include conductive material. A post including conductive material extends from the lower plate and towards the upper plate. An inner plate including conductive material is above and in contact with the post, where the post and the inner plate are separated from the upper plate by dielectric material. The plurality of vias are arranged to at least in part wrap around the post. A signal line extends between the lower and upper plates and at least in part wraps around the post, where the signal line extends through an opening between a first via and a second via of the plurality of vias. In an example, the apparatus is a resonator structure.

### TECHNICAL FIELD

The present disclosure relates generally to signal filters, and more specifically to tunable cavity filters.

### BACKGROUND

A resonator is a device exhibiting resonance or resonant behavior. For example, the resonator may oscillate with a relatively high amplitude at one or more frequencies, which may be the resonance frequencies of the resonator. For example, the amplitude of oscillation at the resonance frequencies may be higher than that at other frequencies. The oscillations in a resonator may be electromagnetic (e.g., such as in the case of microware resonator) or mechanical (e.g., such as in the case of acoustic resonator).

A cavity resonator is a specific type of resonator, e.g., which comprises an electronic device having a space or cavity enclosed by metallic walls. Resonant electromagnetic fields may be excited within the cavity, and may be extracted for use in microwave or radio frequency (RF) systems. In an example, the cavity stores electromagnetic waves (e.g., radio waves), which reflects back and forth between the walls of the cavity. For example, when a source of radio waves at a resonance frequency of the cavity is applied to the cavity, the oppositely-moving waves form standing waves, and the cavity stores electromagnetic energy. In an example, due to a relatively low resistance of the conductive walls of the cavity, cavity resonators may have relatively high Q factor.

Cavity resonators may be designed to act as bandpass filters or bandstop filters. For example, filters having complex frequency response curves may be formed using a plurality of resonator structures. There remain several non-trivial issues with respect to forming filters comprising resonator structures.

### BRIEF DESCRIPTION OF THE DRAWINGS

FIGS. 1A1, 1A2, 1B1, 1B2, 1C1, 1C2, 1D1, 1D2, 1D3, 1D4, and 1F illustrate various views of an example resonator structure, where the resonator structure may be used as a bandstop filter, in accordance with an embodiment of the present disclosure.

FIG. 1E illustrates an example vertical stack of printed circuit boards (PCB) usable to form the resonator structure of FIGS. 1A1-1D4, in accordance with an embodiment of the present disclosure.

FIGS. 2A and 2B illustrate various views of an example filter structure that is a combination of a first bandstop resonator structure and a second bandstop resonator structure, where each of the first and second bandstop resonator structures is similar to the bandstop resonator structure of FIGS. 1A1-1D4, in accordance with an embodiment of the present disclosure.

FIGS. 3A1, 3A2, 3B1, 3B2, 3C1, 3C2, 3D1, 3D2, 3D3, 3D4, and 3E illustrate various views of an example resonator structure that may be used as a bandpass filter, in accordance with an embodiment of the present disclosure.

FIGS. 4A and 4B illustrate various views of an example filter structure that is a combination of a first bandpass resonator structure and a second bandpass resonator structure, where each of the first and second bandpass resonator structures is at least in part similar to the bandpass resonator structure of FIGS. 3A1-3D4, in accordance with an embodiment of the present disclosure.

FIG. 4C illustrate a plan view of another example filter structure that is a combination of a first bandpass resonator structure, a second bandpass resonator structure, and a third bandpass resonator structure, where each of the first, second, and third bandpass resonator structures is at least in part similar to the bandpass resonator structure of FIGS. 3A1-3D4, in accordance with an embodiment of the present disclosure.

FIGS. 5A and 5B illustrate an example filter structure that is a combination of a plurality of bandpass resonator structures and a plurality of bandstop resonator structures, where each of the plurality of bandpass resonator structures is at least in part similar to the bandpass resonator structure of FIGS. 3A1-3D4, and where each of the plurality of bandstop resonator structures is at least in part similar to the bandstop resonator structure of FIGS. 1A1-1D4, in accordance with an embodiment of the present disclosure.

FIG. 6 illustrates an N^{th} order (where N=7 in the example of FIG. 6) extracted-pole filter implemented using a plurality of bandstop resonator structures (e.g., each of which is at least in part similar to the bandstop resonator structure discussed with respect to FIGS. 1A-1D4) and a plurality of bandpass resonator structures (e.g., each of which is at least in part similar to the bandpass resonator structure discussed with respect to FIGS. 3A-3D4), in accordance with an embodiment of the present disclosure.

FIG. 7 illustrates an example implementation of the example seventh order filter of FIG. 6, in accordance with an embodiment of the present disclosure.

FIGS. 8A and 8B illustrate an opening on an upper plate of a bandstop resonator structure of FIGS. 1A1-1D4, to increase a resonance frequency of the bandstop resonator structure, in accordance with an embodiment of the present disclosure.

FIGS. 8C and 8D illustrate an opening on the upper plate of a bandpass resonator structure of FIGS. 3A1-3D4, to increase a resonance frequency of the bandpass resonator structure, in accordance with an embodiment of the present disclosure.

FIG. 8E illustrates an effect of the openings of any of FIGS. 8A-8D on a resonance frequency of the corresponding resonator structure, in accordance with an embodiment of the present disclosure.

FIGS. 9A and 9B illustrate openings or slots on the upper plate of a bandstop resonator structure of FIGS. 1A1-1D4, to decrease a resonance frequency of the bandstop resonator structure, in accordance with an embodiment of the present disclosure.

FIGS. 9C and 9D illustrate openings or slots on the upper plate of a bandpass resonator structure of FIGS. 3A1-3D4, to decrease a resonance frequency of the bandpass resonator structure, in accordance with an embodiment of the present disclosure.

FIG. 9E illustrates an effect of the slots of any of FIGS. 8A-8D on a resonance frequency of the corresponding resonator structure, in accordance with an embodiment of the present disclosure.

FIG. 10 illustrates both slots and openings within the upper plate of a resonator structure of any of FIGS. 1A1-3D4, to increase and/or decrease a resonance frequency of the resonator structure, in accordance with an embodiment of the present disclosure.

FIG. 11A illustrate a flowchart depicting a method for tuning a filter comprising a plurality of resonator structures, e.g., by selectively either forming slots or an opening (or neither slot nor opening) on sections of upper plate of individual resonator structures, in accordance with an embodiment of the present disclosure.

FIGS. 11B and 11C illustrate the example filter of FIG. 11A after the tuning process, in accordance with an embodiment of the present disclosure.

The figures depict various embodiments of the present disclosure for purposes of illustration only and are not necessarily drawn to scale. Numerous variations, configurations, and other embodiments will be apparent from the following detailed discussion.

### DETAILED DESCRIPTION

Disclosed herein are filters comprising resonator structures. In an example, individual resonator structures are relatively small in size (e.g., having a dimension of about λ/7.5), and the filter is implemented in a relatively low-cost printed circuit board (PCB) substrate and has relatively high Q factor. In some embodiments, a filter comprises a plurality of such resonator structures. In some such embodiments, the resonator structures comprise an upper plate that is common and continuous for all the resonator structures, and further comprise a lower plate that is also common and continuous for all the resonator structures. In some embodiments, each resonator structure comprises (i) a corresponding plurality of vias comprising conductive material, each extending from the lower plate to the upper plate, and (ii) a corresponding post comprising conductive material extending from the lower plate upwards towards the upper plate (but not contacting the upper plate). In some such embodiments, each resonator structure further comprises a corresponding inner plate above, and in contact with, the post, where the inner plate comprises conductive material, and is separated from the upper plate by an appropriate dielectric material. Thus, for each resonator structure, a cavity is defined by the upper plate, the lower plate, and the corresponding plurality of vias. For example, the corresponding plurality of vias form a conductive wall or the cavity, which results in formation of a cavity resonator. The post and the inner plate there above are within the cavity (e.g., at a central location of the cavity).

The filter comprises the plurality of such adjacently placed resonator structures. Individual resonator structures can be configured to be a bandpass filter, or a bandstop filter, e.g., based on a profile of a signal line of the resonator structure. For example, a bandstop resonator comprises a signal line that extends from one end of the bandstop resonator to another end of the bandstop resonator. Signal lines are, for example, conductive traces (e.g., comprising one or more metals and/or alloys thereof) implemented on one or more layers of a printed circuit board. In an example, the signal line of the bandstop resonator comprises two extensions (e.g., two stubs), which at least in part (or fully) wraps around or encircles the post of the corresponding resonator structure. In contrast, a bandpass resonator a signal line that extends from one end of the bandpass resonator to a center of the cavity of the bandpass resonator, and terminates within the bandpass resonator. In one embodiment, the signal line of the bandpass resonator includes an extension or stub, which at least in part (or fully) wraps around or encircles the post of the corresponding resonator structure. In an example where there is a first bandpass resonator adjacent to a second bandpass resonator, there is no physical signal line coupling the first and second signal lines. Instead, the first and second bandpass resonators are inductively or electromagnetically coupled to each other.

Due to unintended manufacturing variations, a resonance frequency achieved in a resonator structure may be different from a target or desired frequency. In one embodiment, the resonator structures may be tuned, e.g., after manufacturing the resonator structures, to have a better match between the achieved resonance frequency and the target resonance frequency. In an example, to increase the resonance frequency of the resonator structure after manufacturing of the resonator structure, an opening may be formed within the upper plate of the resonator structure, e.g., above the corresponding inner plate. On the other hand, to decrease the resonance frequency of the resonator structure after manufacturing of the resonator structure, one or more openings or slots may be formed within the upper plate of the resonator structure, e.g., near a periphery of a section of the upper plate of the resonator structure. Numerous variations and embodiments will be apparent in light of the present disclosure.

### General Overview

As mentioned herein above, there remain several non-trivial issues with respect to forming filters comprising resonator structures. For example, microstrip resonators may comprise λ/4 (where λ is the resonance frequency) lengths of transmission line, and may be made compact (e.g., about λ/20 dimension on each side) by meandering or other miniaturization techniques. But such microstrip resonators have relatively low Q factor (e.g., with Q factor being less than 100 is some examples). In another example, waveguide cavity resonators may have relatively high Q factor (e.g., greater than 500 or 1000), but waveguide cavity resonators may be relatively large (e.g., having dimensions of λ/2 on each side). In yet another example, lumped-element resonators comprising inductors and capacitors can be made compact (e.g., having dimensions of λ/20 on each side), but they too suffer from poor Q factor (e.g., less than 50). For some applications, it may be desirable to form a filter that has relatively small size, relatively steep passband-to-stopband roll-off, temperature stability, relatively low insertion loss, and relatively high degree of frequency accuracy.

Accordingly, techniques are described herein to form a filter having relatively small size (e.g., having dimensions on each side of about 27.5) and low-loss, where the filter can be implemented in a relatively low-cost printed circuit board (PCB) substrate and has relatively high Q factor, as will be described herein in further detail. In some embodiments, the filter described herein comprises a plurality of resonator structures. In some such embodiments, the resonator structures comprise an upper plate that is common and continuous for all the resonator structures, and further comprise a lower plate that is also common and continuous for all the resonator structures. The upper plate is above the lower plate. In an example, the upper and lower plates form ground planes of the filter, and comprises conductive material, such as one or more metals (e.g., copper) and/or alloys thereof.

In one embodiment, each resonator structure comprises a corresponding plurality of conductive vias extending from the lower plate to the upper plate. The vias comprise one or more metals (e.g., copper) and/or alloys thereof. A via can be of solid metal, or may be a metal-lined hole with a dielectric material in a core section of the via. Examples of dielectric material within a via core include air, vacuum, foam, resin, epoxy, and/or another appropriate dielectric material.

In one embodiment, each resonator structure further comprises a corresponding conductive post extending from the lower plate upwards towards the upper plate (but not contacting the upper plate). Both the post and the vias comprise metal and/or metal alloys, and extend upwards from the lower layer. However, the vias extend upward and contact the upper plate. In contrast, the post doesn't contact the upper plate. Thus, a height of an individual via is more than a height of the post. In one embodiment, within a resonator structure, the plurality of vias at least in part encircles or wraps around the post.

In one embodiment, each resonator structure further comprises a corresponding inner plate above, and in contact with, the post. The inner plate, also referred to herein as a “post plate”, comprise conductive material, and is separated from the upper plate by an appropriate dielectric material. Thus, a capacitor is formed between the inner plate and the upper plate.

In one embodiment, for each resonator structure, a cavity is defined by the upper plate, the lower plate, and the corresponding plurality of vias. For example, the corresponding plurality of vias form a conductive wall or the cavity, which results in formation of a cavity resonator.

The post and the inner plate there above are within the cavity (e.g., at a central location of the cavity). In an example, due to presence of the post and the inner plate at or near a center of the cavity, the cavity resonator is an evanescent-mode cavity resonator structure. In an example, the wall of the cavity is not a solid wall-rather, the wall comprises the plurality of vias having gaps therewithin.

Thus, the filter comprises the plurality of such adjacently placed resonator structures. Individual resonator structure can be configured to be a bandpass filter, or a bandstop filter, e.g., based on a profile of a signal line of the resonator structure.

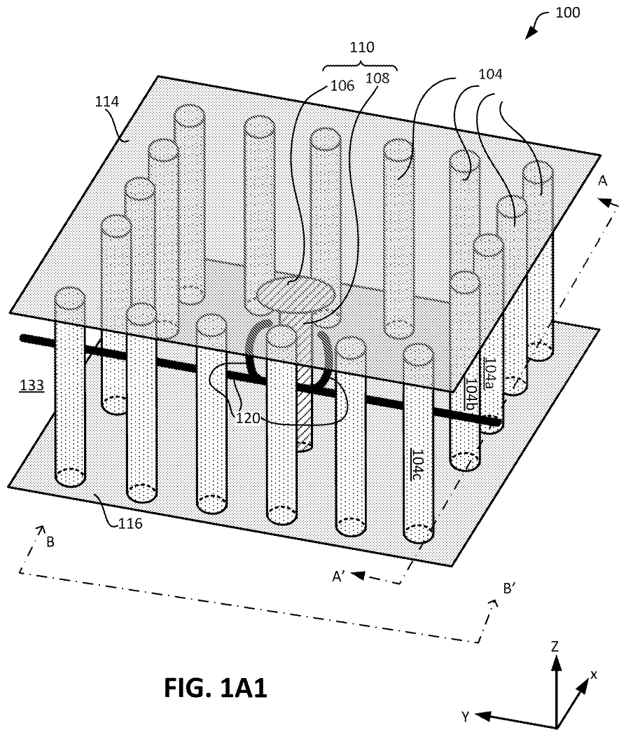

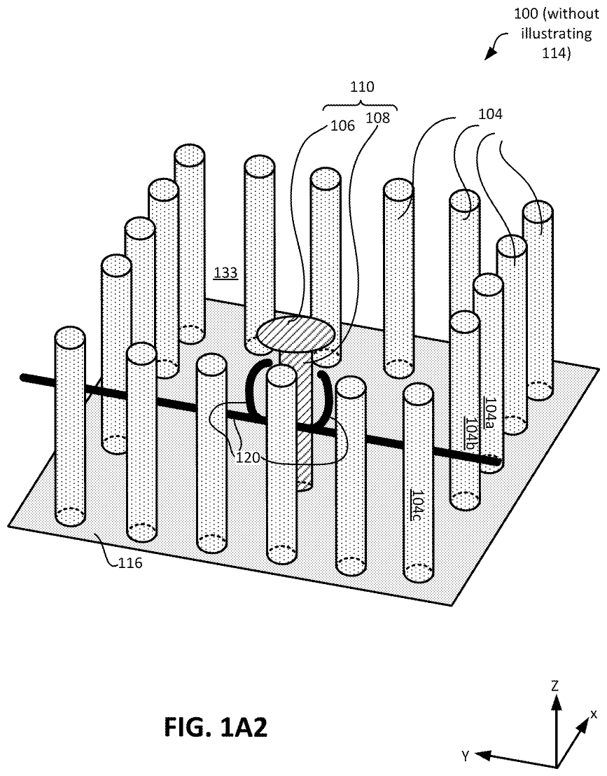

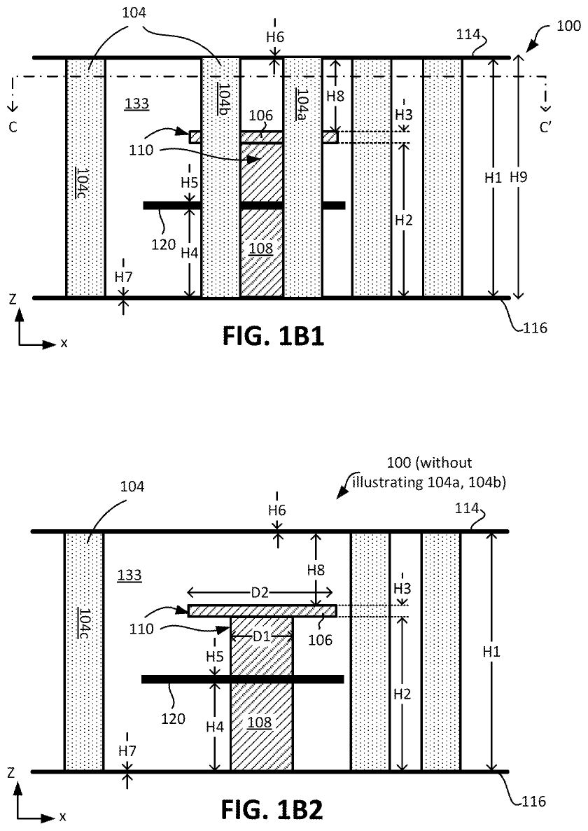

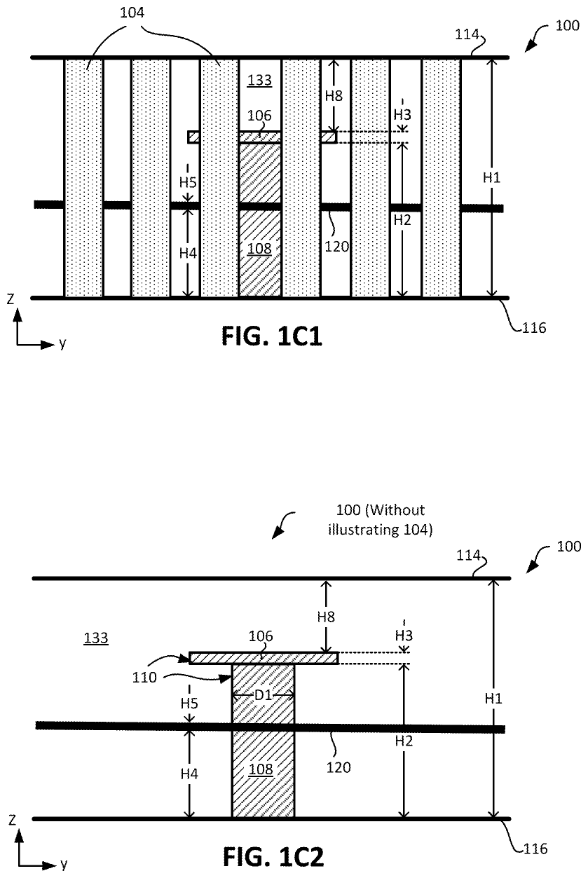

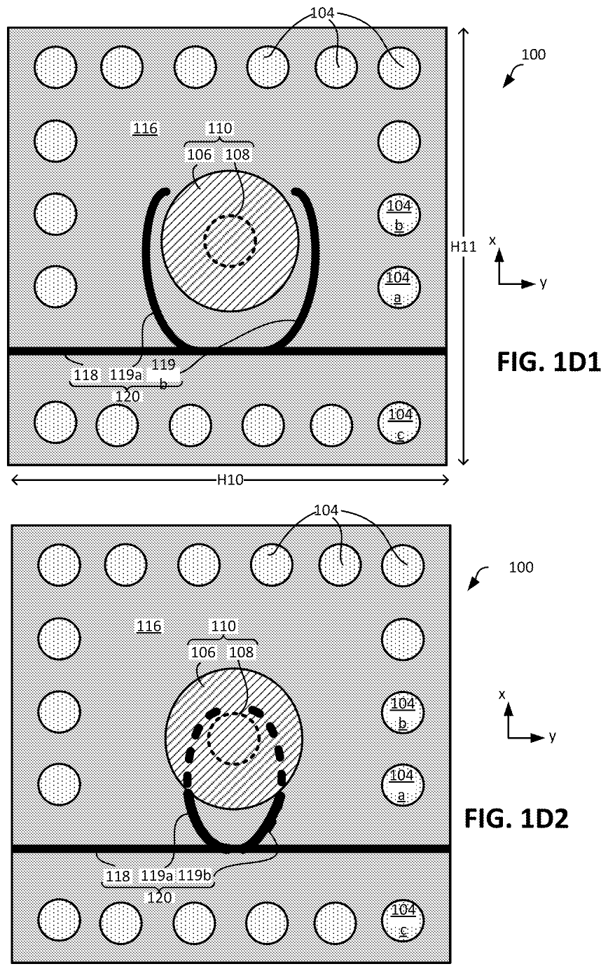

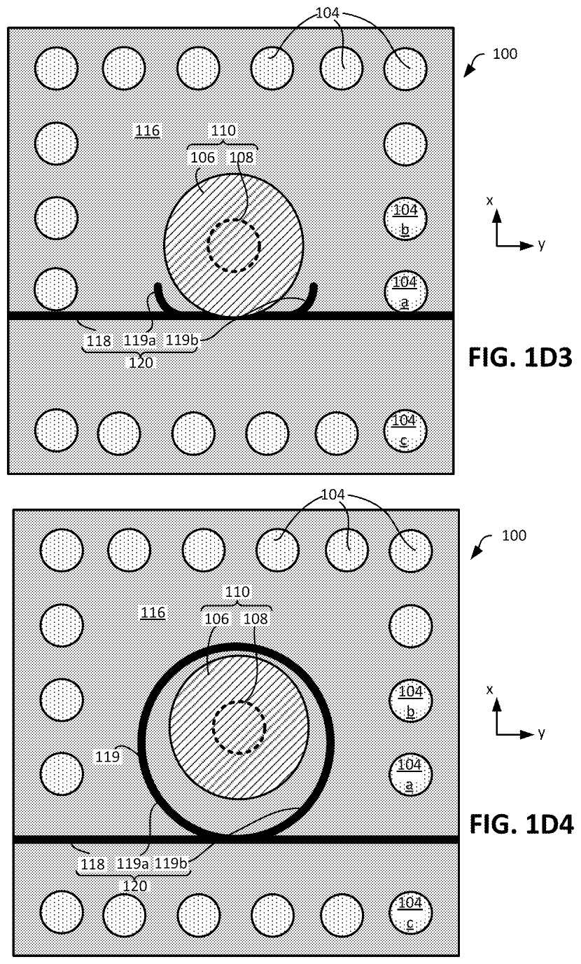

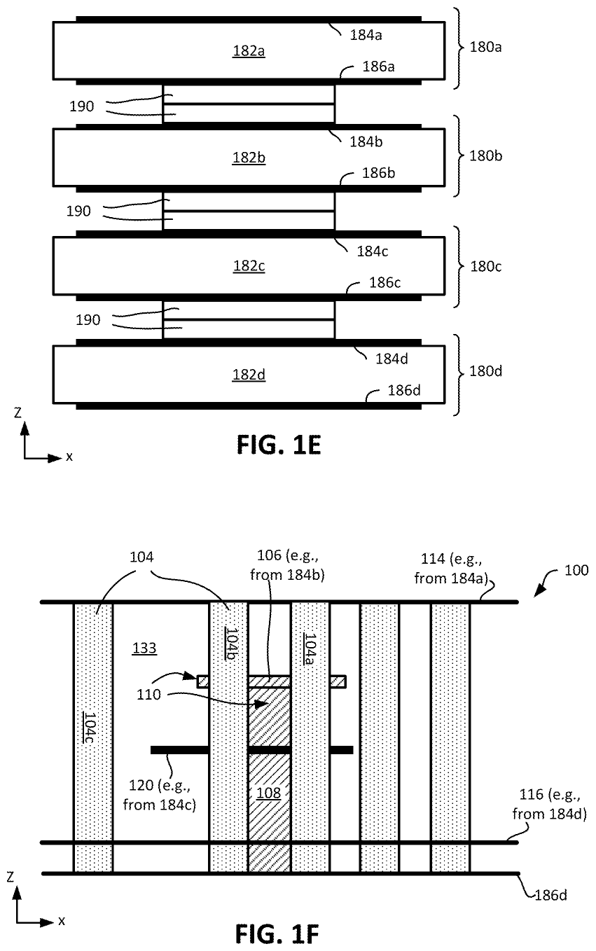

For example, a bandstop resonator filter structure (also referred to herein as bandstop resonator) comprises a signal line (e.g., a signal line 120 of FIGS. 1A1-1D4) that extends from one end of the bandstop resonator to another end of the bandstop resonator. For example, the signal line enters the bandstop resonator through a gap between two vias on one end of the bandstop resonator, and exits the bandstop resonator through another gap between two other vias on another opposing end of the bandstop resonator. In some examples, the signal line extends between the upper plate and the lower plate, and is substantially parallel to one or both the upper plate and the lower plate. In some such examples, the signal line is at a horizontal plane that is at a lower level than a horizontal plane of the inner plate. In one embodiment, the signal line of the bandstop resonator comprises two extensions (e.g., two stubs), which at least in part (or fully) wraps around or encircles the post of the corresponding resonator structure. The signal line of the bandstop resonator is part of a source-to-load transmission line. The source-to-load transmission signal line has the two extensions at least in part wrapping around the post. The magnetic field of these extensions couples with the magnetic field of the vias, the post, and the inner plate. Thus, as a signal passes through the signal line of the resonator structure, the signal (e.g., energy of the signal) transmitted over the signal line couples to the resonator structure (e.g., couples to the vias, the post, and the inner plate), to form a bandstop filter.

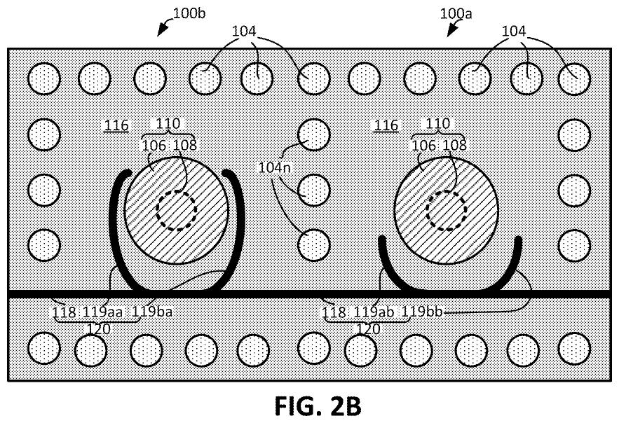

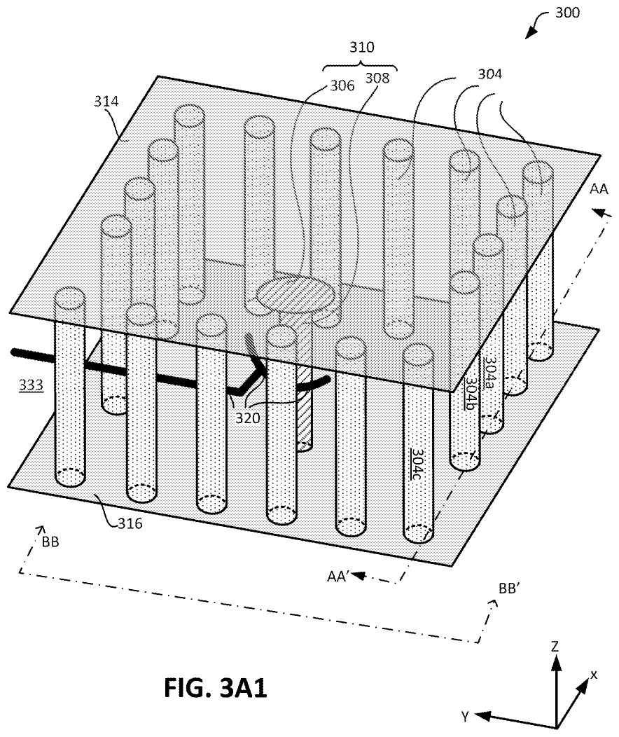

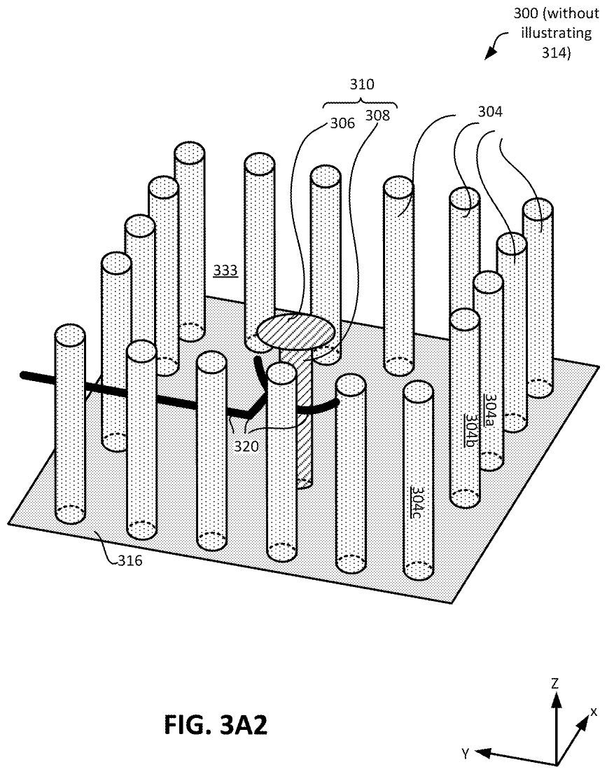

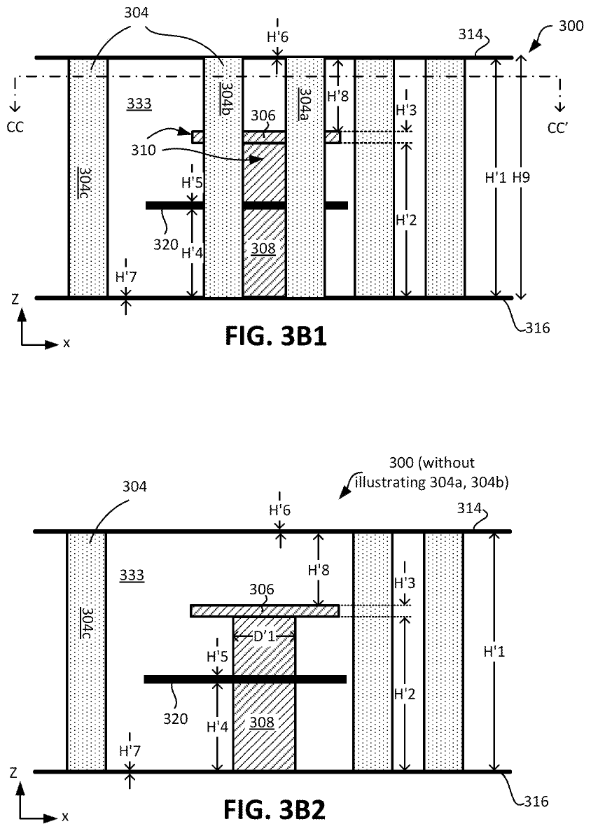

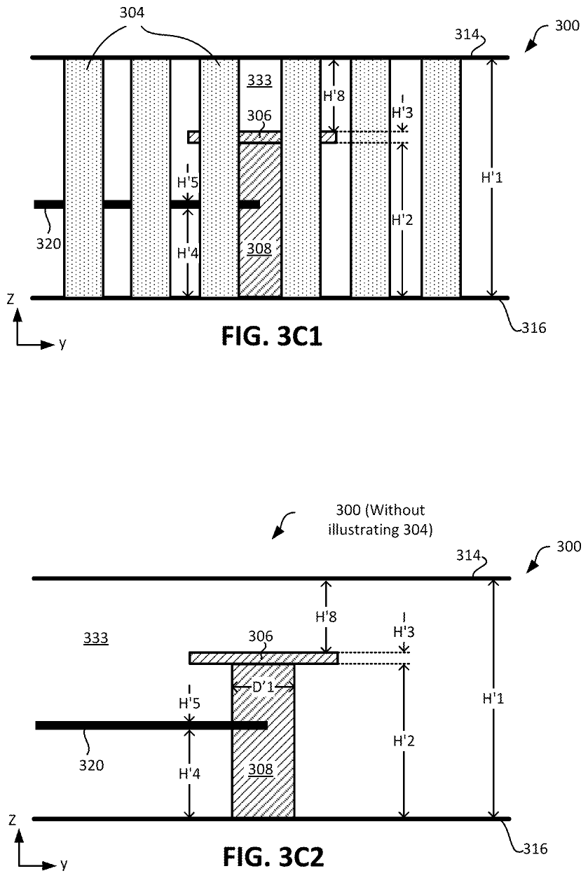

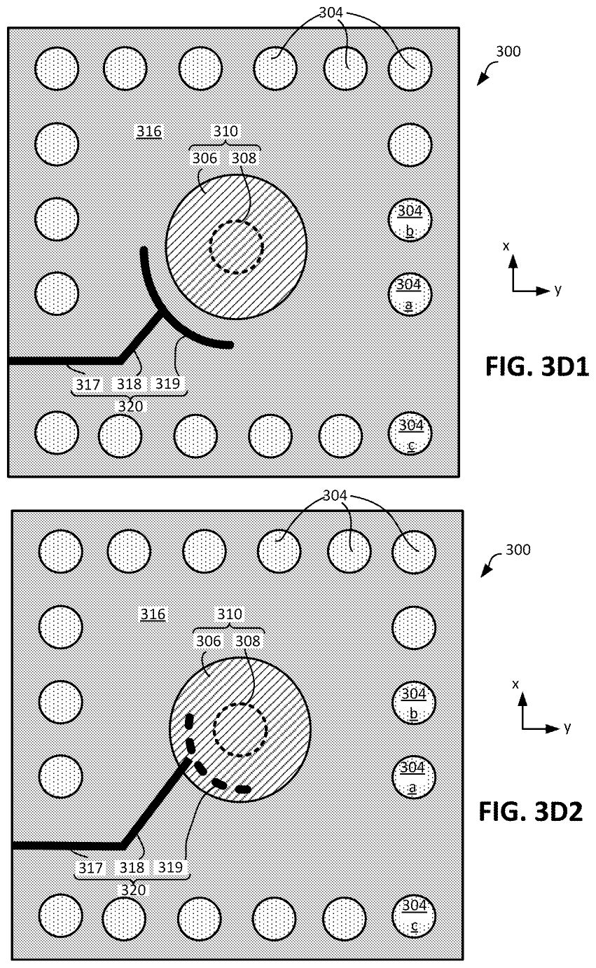

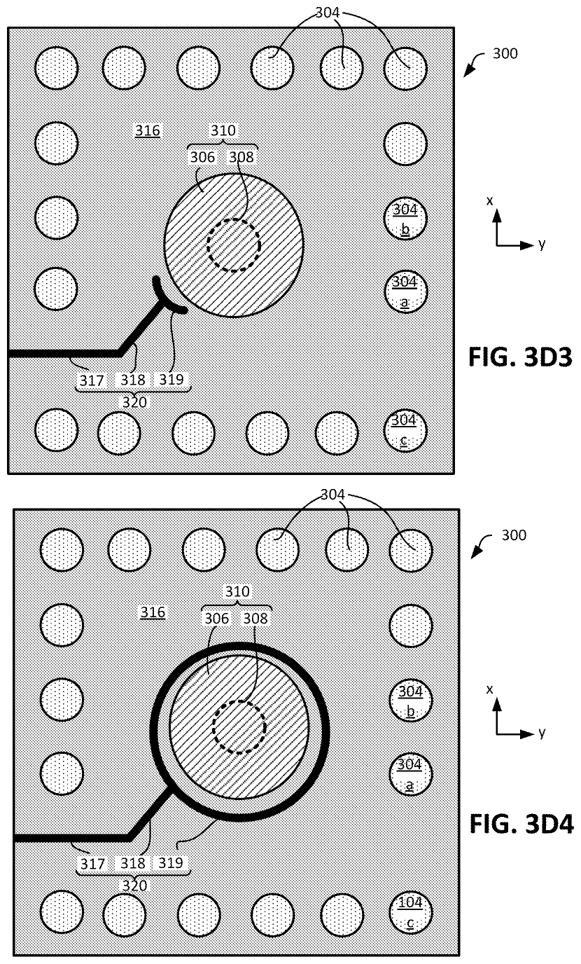

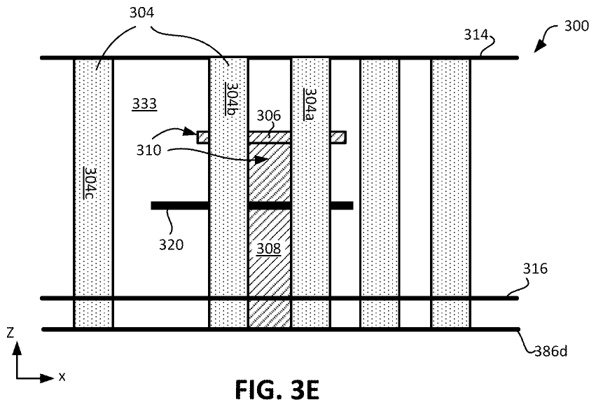

On the other hand, a bandpass resonator filter structure (also referred to herein as bandpass resonator) comprises a signal line (e.g., a signal line 320 of FIGS. 3A1-3D4) that extends from one end of the bandpass resonator to a center of the cavity of the bandpass resonator, and terminates within the bandpass resonator. For example, the signal line enters the bandpass resonator through a gap between two vias on one end of the bandstop resonator, and terminates neat the corresponding post. In some examples, the signal line extends between the upper plate and the lower plate, and is substantially parallel to one or both the upper plate and the lower plate. In some such examples, the signal line is at a horizontal plane that is at a lower level than a horizontal plane of the inner plate. In one embodiment, the signal line of the bandpass resonator includes an extension or stub, which at least in part (or fully) wraps around or encircles the post of the corresponding resonator structure.

In one embodiment, a first bandpass resonator may be adjacent to a second bandpass resonator. For example, a first signal line enters the first bandpass resonator and terminates within the first bandpass resonator. Similarly, a second signal line enters the second bandpass resonator and terminates within the second bandpass resonator. Thus, there is no physical signal line coupling the first and second signal lines. Instead, the first and second bandpass resonators are inductively or electromagnetically coupled to each other.

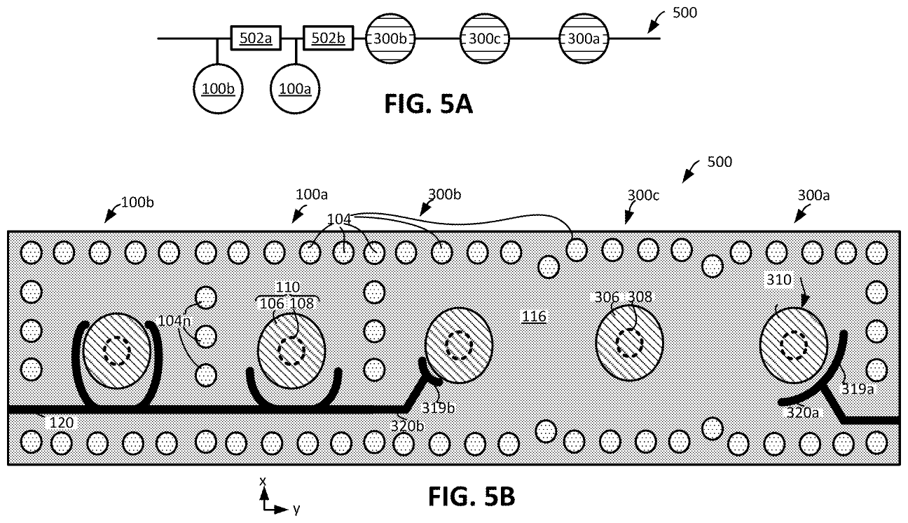

In some examples, an intervening bandpass resonator is between the above discussed first and second bandpass resonators (e.g., FIGS. 5B and 7 illustrate three adjacent bandpass resonators). In some such examples, the intervening bandpass resonator may not have any signal line extending through it. Rather, in some such examples, the intervening bandpass resonator inductively or electromagnetically couples the above discussed first and second bandpass resonators that are immediate adjacent to, and on two sides of the intervening bandpass resonator.

In one embodiment, a resonance frequency of any of the above discussed resonator structures may be tuned, e.g., by selecting dimensions of various components of the resonator structure. In an example, the resonator structures discussed herein may achieve a resonance frequency that is within a radio frequency (RF) range, such as within a range of 5 GHz to 30 GHz, such as in a subrange of 5 GHz to 20 GHZ, or 5 GHz to 10 GHz, or 10 GHz to 30 GHz, or 10 GHz to 20 GHz, for example. In an example, a dimension of individual resonator structure is equal to about N/7.5 mm. For example, for 20 GHz resonance frequency, the dimension of individual resonator structure is about 15/7.5 mm, e.g., 2 mm. As will be discussed herein in further detail, the resonator structures are formed using a plurality of vertically stacked PCBs, e.g., see FIGS. 1E, 1F, and 3E. Resonator structures discussed herein may achieve high quality factor (Q factor), such as quality factor of at least 100, or at least 200, or at least 300, or at least 400, or at least 500, or at least 700, or at least 1000, or at least 1500, or at least 1700, or at least 2000.

Manufacturing processes, such as those employed to manufacture the bandpass and/or bandstop resonator structures discussed herein, may have some random variations, e.g., due to limitations in the manufacturing processes. Such manufacturing variations may be problematic in some filters, such as narrowband filters, e.g., which may have relatively stringent passband insertion loss and stopband rejection requirements with relatively narrow range of frequencies allowed to transition between passband and stopband. In some examples, frequency-tuning mechanisms may be adapted, e.g., by patterning specific features in the upper plate of the resonator structures, to tune the resonance frequencies of the resonator structures described herein.

For example, for a given resonator structure, the resonance frequency achieved after manufacturing may be more than, or less than, a target or desired resonance frequency. In an example, in order to increase the resonance frequency of the resonator structure after manufacturing of the resonator structure, an opening may be formed within the upper plate of the resonator structure, e.g., above the corresponding inner plate. In an example, the opening reduces surface area of the upper plate above the inner plate, and hence, reduces the effective capacitance between the upper plate and the inner plate. This results in an increase in the resonance frequency of the resonator structure.

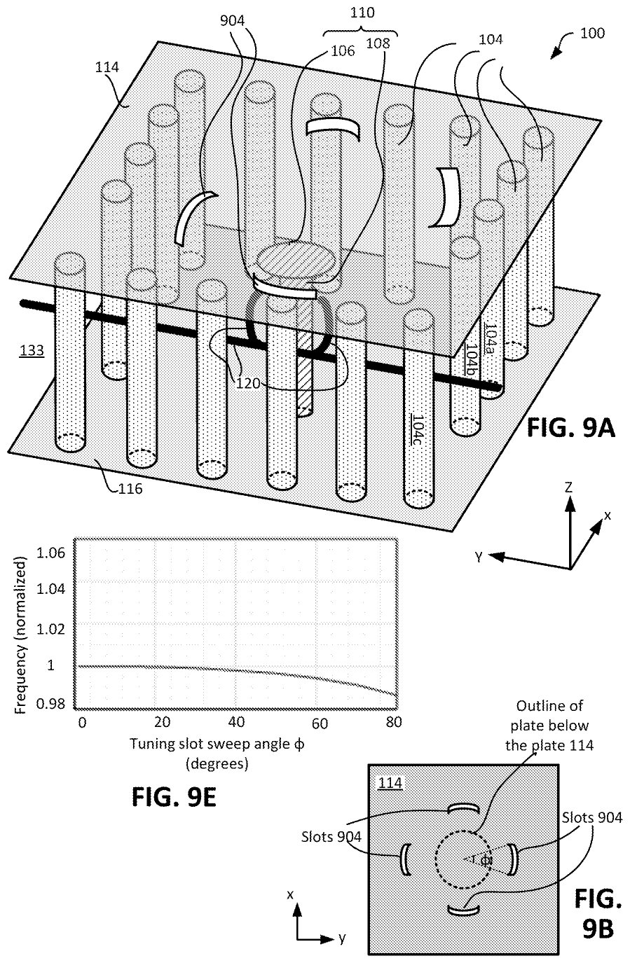

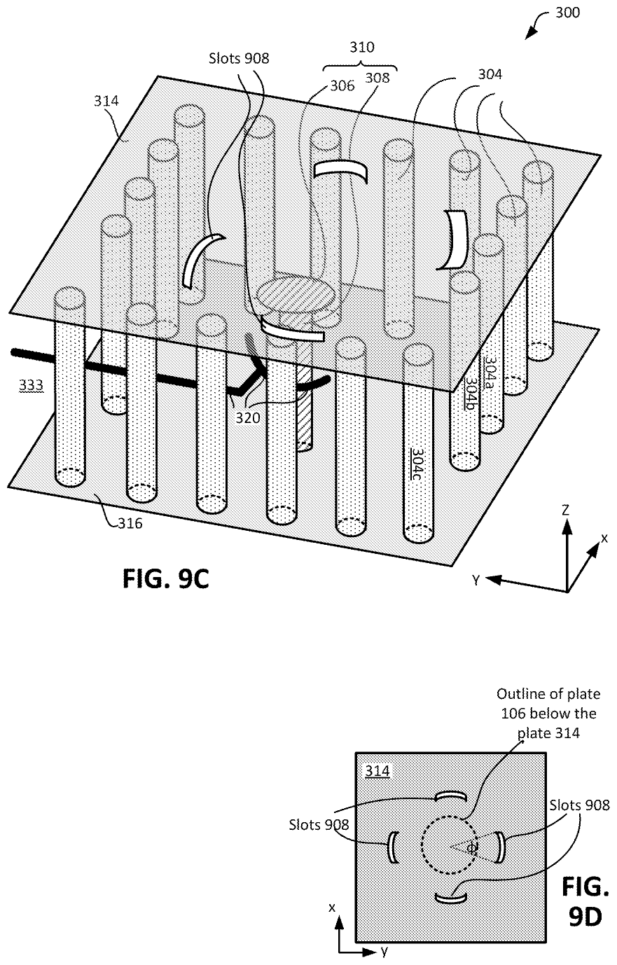

On the other hand, in order to decrease the resonance frequency of the resonator structure after manufacturing of the resonator structure, one or more openings or slots may be formed within the upper plate of the resonator structure, e.g., near a periphery of the upper plate. The slots force the current flowing on the surface of the upper plate to travel a longer path, thereby increasing an effective inductance and consequently lowering the resonant frequency. As illustrated in FIGS. 9A-9D, in an example, the slots are not above the inner plate, but rather on a section of the upper plate that is between the inner plate and the vias.

In accordance with some embodiments of the present disclosure, these various approaches can be used individually or together to form filters using resonator structures. Numerous variations and embodiments will be apparent in light of the present disclosure.

As used in the discussion and claims herein, the term “about” indicates that the value listed may be somewhat altered, as long as the alteration does not result in nonconformance of the process or device. For example, for some elements the term “about” can refer to a variation of +0.1%, for other elements, the term “about” can refer to a variation of +1% or +10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

### Architecture—Resonator and Filter Structures

FIGS. 1A1, 1A2, 1B1, 1B2, 1C1, 1C2, 1D1, 1D2, 1D3, 1D4, and 1F illustrate various views of an example resonator structure 100, where the resonator structure 100 may be used as a bandstop filter, in accordance with an embodiment of the present disclosure.

FIG. 1A1 illustrates a perspective of the resonator structure 100 (also referred to herein as “structure 100”). An upper plate 114 of the structure 100 is illustrated to be semitransparent in FIG. 1A1 for purposes of illustrative clarity (e.g., such that components below the upper plate 114 are visible), although the upper plate 114 may not be semitransparent in actual implementation.

FIG. 1A2 the perspective of the resonator structure 100, without illustrating the upper plate 114 (e.g., such that components below the upper plate 114 are visible). FIG. 1B1 illustrates a cross-sectional view of the structure 100, e.g., along line A-A′ of FIG. 1A1. FIG. 1B2 illustrates another cross-sectional view of the structure 100 along line A-A′ of FIG. 1A1, but without illustrating one or more vias (such as vias 104a, 104b) of the structure 100 (such that components that would have been covered by the vias 104a, 104b would be visible in the view of FIG. 1B2).

FIG. 1C1 illustrates a cross-sectional view of the structure 100, e.g., along line B-B′ of FIG. 1A1. FIG. 1C2 illustrates another cross-sectional view of the structure 100 along line B-B′ of FIG. 1A1, but without illustrating the vias 104 of the structure 100 (such that components that would have been covered by the vias 104 would be visible in the view of FIG. 1C2).

FIGS. 1D1, 1D2, 1D3, and 1D3 illustrate various example cross-sectional views of the structure 100, e.g., along line C-C′ of FIG. 1B1. Thus, FIGS. 1D1, 1D2, 1D3, and 1D3 illustrate example plan views of the structure 100, without illustrating the upper plate 114.

FIG. 1F illustrates a cross-section view that is in part similar to the cross-section view of FIG. 1B1. FIG. 1F illustrates a metal layer or plate 186d below a lower plate 116, and this figure will be discussed with respect to FIG. 1E herein in turn.

Referring to FIGS. 1A1-1C2, in an example, the structure 100 comprises a lower plate 116 comprising conductive material and an upper plate 114 comprising conductive material, where the upper plate 114 is above the lower plate 116. For example, the upper and lower plates 114, 116 comprise one or more metals (or non-metal coated with metal) and/or alloys thereof. As illustrated, the upper and lower plates 114, 116 extend in the horizontal plane (e.g., X-Y plane) and are substantially parallel to each other.

The components 114, 116 are referred to herein as “plates” of conductive material, but can also be referred as sheets or layers of conductive material. As illustrated in the perspective view of FIGS. 1A1-A2 and the plane views of FIGS. 1D1-1D4, each of the plates 114, 116 has a rectangular or a square shape, although other appropriate shapes (such as a parallelogram, a rhombus, a circular, or another appropriate shape) may also be possible.

In one embodiment, the structure 100 comprises a conductive component 110. In an example, the component 110 comprises a post 108, and a plate 106 above and in contact with the post 108. In an example, the component 110, including the post 108 and the plate 106, comprises conductive material, such as one or more metals and/or alloys thereof (or non-metal coated by metal). The post 108 is like a solid or hollow pillar, which extends from the lower plate 116 upward towards the upper plate 114. The plate 106 is a conductive layer or surface above and in contact with the post 108. To better distinguish the plate 106 from the upper and lower plates 114, 116, the plate 106 is also referred to herein as “inner plate” or “central plate” or “intermediate plate” (e.g., given the location of the plate 106 between the upper and lower plates 114, 116) in some examples.

As illustrated in the cross-sectional views of FIGS. 1B1, 1B2, 1C1, and 1C2, the component 110, such as the post 108, is in contact with the lower plate 116. The component 110, however, is not in contact with the upper plate 114. For example, as illustrated in FIGS. 1B1-1C2, the plate 106 (e.g., an upper surface of the plate 106) is vertically separated from the upper plate 114 (e.g., the lower surface of the upper plate 114) by a distance of H8, where H8 is measured in the Z-axis direction, e.g., a direction orthogonal to a surface of the plates 114, 116, 106. For example, dielectric material 133 is between the plates 106, 114.

In an example, a resonance frequency of the resonator structure 100 may be tuned by adjusting the distance H8 and/or a diameter D2 (see FIG. 1B2) of the plate 106. In an example, a capacitance between the plates 106 and 144, and hence the resonance frequency of the resonator structure 100, is based on the distance H8 and/or the diameter D2. For example, reducing the distance H8 may result in increase in the capacitance between the plates 106 and 114, and resultant decrease in the resonance frequency of the resonator structure 100. Also, decreasing the diameter D2 may result in decrease in the capacitance between the plates 106 and 114, and resultant increase in the resonance frequency of the resonator structure 100. Merely as an example, the distance H8 may be in the range of 0.05 mm to 1 mm, such as in a subrange of 0.05 mm to 0.8 mm, or 0.05 mm to 0.5 mm, or 0.05 mm to 0.25 mm, or 0.1 mm to 1 mm, or 0.1 mm to 0.5 mm, or 0.1 mm to 0.25 mm, or 0.2 mm to 1 mm, or 0.2 mm to 0.5 mm, for example.

In an example, as also illustrated in FIGS. 1B1-1B2, the plate 106 has a thickness (e.g., measured in the Z-axis or vertical direction) of H3. H3, for example, is within a range of 0.001 mm to 0.2 mm. As will be described herein in turn (e.g., with respect to FIG. 1E), in an example, the plate 106 is formed by appropriately patterning a metal layer of a printed circuit board (PCB). In such an example, a thickness of the plate 106 may be based on a thickness of the metal layer of the PCB.

In some examples, an upper surface of the plate 106 has circular shape, e.g., as illustrated in the plan views of FIGS. 1D1-1D4. In some other examples, the upper surface of the plate 106 may have another appropriate shape, such as square or rectangular. A surface area of the upper surface of the plate 106 at least in part dictates a capacitance between the plates 106 and 114, and the surface area of the upper surface of the plate 106 may be tuned, to tune the resonance frequency of the resonator 100.

In one embodiment, the post 108 comprises one or more metals (such as copper) and/or alloys thereof. In some examples, the post 108 comprises a solid metal post. In some other examples, the post 108 comprises a layer of metal around a dielectric material. In some such examples, the dielectric material may simply be air (or vacuum), resulting in a hollow pillar for the post 108. In some other such examples, the dielectric material may be another appropriate dielectric material, such as foam, resin, epoxy, and/or another appropriate dielectric material.

As illustrated in FIGS. 1B1-1C2, the post 108 has a height of H2, where H2 is measured in the Z-axis direction (e.g., a direction orthogonal to a surface of the plates 114, 116, 106). In an example, the distance H2 may be in the range of 0.5 mm to 3 mm, such as in a subrange of 0.5 mm to 2 mm, or 1 mm to 1.7 mm, or 1.25 mm to 3 mm, or 1.25 mm to 2 mm, for example.

In one embodiment, the structure 100 comprises a plurality of vias 104. As illustrated, the vias 104 are arranged to at least in part surround or wrap around the component 110 (e.g., see the plan views of FIGS. 1D1-1D4). Each via 104 extends from an upper surface of the lower plate 116 to a lower surface of the upper plate 114. Thus, the vias 104 extend vertically from the lower plate 116 to the upper plate 114.

In one embodiment, individual via 104 has a height of H1, where H1 is measured in the Z-axis direction, e.g., a direction orthogonal to a surface of the plates 114, 116, 106. In some examples, the height H1 may be in the range of 1 mm to 4 mm, such as in a subrange of 1 mm to 3 mm, or 1 mm to 2 mm, or 1.5 mm to 4 mm, or 1.5 mm to 3 mm, or 1.5 mm to 2 mm, for example. In one such example, the height H1 may be about 2 mm. Some example posts 104a, 104b, 104c are labelled in some of FIGS. 1A1-1B2, and will be described in further detail herein.

As illustrated in the plan views of FIGS. 1D1-1D4, in some example, the posts 104 are arranged in a rectangular manner around the component 110. However, in some other examples, the posts 104 may be arranged around the component 110 in another appropriate geometrical shape, such as in circular or oval or semi-circular shape.

Thus, the vias 104 form a wall around the component 110 comprising the post 108 and the plate 106. Note that such a wall comprising the vias 104 is not a solid continuous wall, due to the gaps between the vias 104.

In one embodiment, the vias 104 and the component 110 are at least in part encapsulated by dielectric material 133. For example, the dielectric material 133 is between the upper plate 114 and the lower plate 116, and at least in part around the vias 104 and the component 110.

Any appropriate dielectric material 133 may be used. In an example, the dielectric material 133 is a low loss dielectric material that is appropriate for RF applications. In an example, using low loss dielectric material 133 results in reduction is a size of the structure 100, where the reduction in the size is proportional to √(ϵ_{R}), where ϵ_{R} is a dielectric permittivity of the dielectric material 133.

As will be described herein in turn, various plates 106, 114, 116 are formed from appropriate metal layers of stacked PCBs (e.g., see FIG. 1E), and the dielectric material 133 is a dielectric material or substrate used in a PCB, such as a laminate, a resin, FR4, porcelain, mica, glass, plastics, and/or other appropriate dielectric materials used in a PCB.

In one embodiment, the structure 100 further comprises a signal line 120 traversing from one end of the structure 100 to another end of the structure 100. The signal line 120 comprises conductive material, such as one or more metals (e.g., copper) and/or alloys thereof.

As illustrated in FIGS. 1A1-1D4, the signal line 120 extends between the upper plate 114 and the lower plate 116. For example, the signal line 120 is substantially parallel to one or both the upper plate 114 and the lower plate 116 (note that the upper plate 114 and the lower plate 116 are parallel to each other in some examples).

In an example, the signal line 120 extends from a first end of the structure 100 to an opposing second end of the structure 100. For example, the signal line 120 extends through an opening between the vias 104a and 104c on a first end of the structure 100, and similarly extends through another opening between two other vias (not labelled) on an opposing second end of the structure 100.

As illustrated in FIGS. 1B1, 1B2, 1C1, and 1C2, the signal line 120 is at a horizontal plane that is at a lower level than a horizontal plane of the plate 106. For example, at least a part of (or an entirety) of the signal line 120 extends within a first horizontal plane, at least a part of (or an entirety) the plate 106 extends within a second horizontal plane, where the second horizontal plane is above the first horizontal plane. For example, the second horizontal plane is closer to the upper plate 114 than the first horizontal plane. Thus, the plate 106 is closer to the upper plate 114 than the signal line 120. Similarly, the plate 106 is farther from the lower plate 116 than the signal line 120.

As illustrated in FIGS. 1A1, 1A2, 1D1-1D4, the signal line 120 has multiple components. For example, referring to FIGS. 1D1-1D4, a component 118 of the signal line 120 is substantially straight, and extends from one end of the structure 100 (e.g., extends through the opening between the vias 104a and 104c) to another end of the structure 100 (e.g., extends through the opening between two other the vias that are not specifically labelled in the figures).

The signal line 120 further comprises components 119a, 119b, where each of the components 119a, 119b extends from the component 118 and at least in part wraps around the post 108. As the components 119a, 119b extends from the component 118, the components 119a, 119b are also referred to herein as extension sections, extensions, or stubs of the signal line 120. FIGS. 1D1, 1D2, 1D3, and 1D4 respectively illustrate four example configurations of the components 119a, 119b of the signal line 120.

For example, in FIG. 1D1, none of the components 118, 119a, 119b are below the plate 106. As illustrated in FIG. 1D1, each of the components 119a, 119b extends from the component 118 and at least in part wraps around the post 108.

In the example of FIG. 1D2, at least a section of each of the components 119a, 119b is below the plate 106, and such sections are illustrated using dotted line in FIG. 1D2. It may be noted that as discussed herein above, the signal line 120 is at a horizontal plane that is at a lower level than a horizontal plane of the plate 106. As illustrated in FIG. 1D2, each of the components 119a, 119b extends from the component 118 and at least in part wraps around the post 108.

In the example of FIG. 1D3, a wrapping of the components 119a, 119b around the post 108 is relatively less (e.g., less than the examples illustrated in FIGS. 1D1, 1D2, and 1D4). Thus, a length of each of the components 119a, 119b in FIG. 1D3 is less than those of FIGS. 1D1, 1D2, and 1D4.

In the example of FIG. 1D4, the components 119a, 119b combine to form a common component 119 that fully wraps around or encircles the post 108. Although in this example the plate 108 (or the post 106) and the component 119 are not concentric, in another example, the post 106 and the component 109 may be concentric (e.g., which may be possible by appropriately spacing the component 118 of the signal line 120 with respect to post 106 and the plate 108.

In an example, a cavity is defined in the structure 100, where the wall comprising the vias 104 defines sidewalls of the cavity, and the upper plate 114 and the lower plate 116 define upper and lower surfaces of the cavity, respectively. Thus, a cavity resonator is formed by the structure 100.

In an example, due to presence of the post 108 and the plate 106 at or near a center of the cavity, the cavity resonator is an evanescent-mode cavity resonator structure. As illustrated, the wall of the cavity of the structure 100 is not a solid wall-rather, the wall comprises vias 104 having gaps therewithin (such as a gap between two adjacent vias 104a and 104b). A gap between two adjacent vias is configurable, and may be altered, e.g., to tune cutoff frequencies and/or resonance frequency of the resonator structure 100.

In an example, the structure 100 is loaded with an effective inductor and capacitor structure comprising the central component 110 (e.g., including the post 108 and the plate 106). The post 108 forms an inductance proportional to its height H2 and/or inversely proportional to its diameter D1 (e.g., see FIG. 1B2 for H2 and D1). The plate 106 forms a parallel plate capacitance with the upper plate 114. In an example, increasing the inductance and/or capacitance may reduce the cavity's resonance frequency, leading to a smaller size of the structure 100 for a given resonance frequency.

As illustrated in FIGS. 1A1-1D4, the signal line 120 is part of a source-to-load transmission line. The source-to-load transmission signal line 120 has the two stubs or extensions 119a, 119b at least in part wrapping around the central post 108 of the structure 100. The magnetic field of these extensions 119a, 119b couples with the magnetic field of the vias 104 and the component 110 (e.g., comprising the post 108 and the plate 106). Thus, as a signal passes through the signal line 120 of the resonator structure 100, the signal (e.g., energy of the signal) transmitted over the signal line 120 couples to the resonator structure 100 (e.g., couples to the vias 104 and the component 110), to form a bandstop filter.

In an example, a length of the extensions 119a, 119b may determine a strength of the coupling between the signal line 120 and the resonator structure 100 (e.g., the vias 104 and the component 110). For example, the more the signal line 120 wraps around the post 108, the more tightly is the signal line 120 coupled to the resonator structure 100. Thus, the above discussed coupling is tighter in the examples of FIGS. 1A1, 1D2, and 1D4, compared to that in the example of FIG. 1D3.

For example, the wrapping and/or length of the extensions 119a, 119b may be altered, to achieve a desired filter transfer function. Thus, the wrapping and/or length of the extensions 119a, 119b in the four example scenarios depicted in FIGS. 1D1-1D4 are all different, and hence, the filter transfer function achieved in FIGS. 1D1-1D4 are all correspondingly different.

In an example, the structure 100 is substantially enclosed by the upper and lower plates 114, 116, as well as the fence like cavity walls comprising the vias 104. This results in reduced radiation losses and coupling to nearby devices, in an example.

As discussed herein, a resonance frequency of the structure 100 may be tuned, e.g., by selecting the various dimensions illustrated in FIGS. 1B1-1C2. In an example, the resonator structure 100 may achieve a resonance frequency that is within a radio frequency (RF) range, such as within a range of 5 GHz to 30 GHz, such as in a subrange of 5 GHz to 20 GHz, or 5 GHz to 10 GHz, or 10 GHz to 30 GHz, or 10 GHz to 20 GHz, for example. In an example, a dimension H19 (see FIG. 1B1, where H9=H1+sum of thicknesses of the upper and lower plates) is related to the resonance frequency λ as follows: H9≈N/7.5 mm. For example, for 20 GHz resonance frequency, the height H9≈15/7.5 mm, e.g., 2 mm.

In an example, the structure 100 has a shape of a cube. For example, dimensions H10 and/or H11 of the upper plate 114 (see FIG. 1D1) are substantially equal to the dimension H9. For example, each of H10 and H11 differs from H9 by at most 0.01 mm, or at most 0.02 mm. In an example, the dimensions H10 and H11≈N/7.5 mm. Thus, for 20 GHz resonance frequency, for example, the dimensions H10 and H11≈15/7.5 mm, e.g., 2 mm.

As discussed herein above, the resonator structure 100 acts as a bandstop filter, and the resonant frequencies of the bandstop filter may be tuned by, for example, tuning the various dimensions illustrated in FIGS. 1B1-1D4, and/or by controlling the extent of wrapping of the post 108 by the extensions 119a, 119b of the signal line 120. Testing has shown that the resonator structure 100 may achieve high quality factor (Q factor), such as quality factor of at least 100, or at least 200, or at least 300, or at least 400, or at least 500, or at least 700, or at least 1000, or at least 1500, or at least 1700, or at least 2000.

In an example, the structure 100 is a printed circuit board (PCB) based structure comprising a vertical stack of PCBs. FIG. 1E illustrates an example vertical stack of printed circuit boards (PCB) 180a, 180b, 180c, 180d usable to form the structure 100 of FIGS. 1A1-1D4, in accordance with an embodiment of the present disclosure. Each of the PCBs 180a, . . . , 180d may have an upper metal layer 184 and a lower metal layer 186, and a dielectric material layer 182 sandwiched between the upper and lower metal layers. For example, the PCB 180a has an upper metal layer 184a and a lower metal layer 186a, and a dielectric material layer 182a sandwiched between the upper and lower metal layers 184a, 186a. Similarly, the PCB 180b has an upper metal layer 184b and a lower metal layer 186b, and a dielectric material layer 182b sandwiched between the upper and lower metal layers 184b, 186b. Similarly, the PCB 180c has an upper metal layer 184c and a lower metal layer 186c, and a dielectric material layer 182c sandwiched between the upper and lower metal layers 184c, 186c. Similarly, the PCB 180d has an upper metal layer 184d and a lower metal layer 186d, and a dielectric material layer 182d sandwiched between the upper and lower metal layers 184d, 186d.

Vertically adjacent PCBs (such as PCBs 180a and 180b, or PCBs 180b and 180c, and so on) may be held together using adhesive layers 190. In an example, the dielectric material layers 182a, . . . , 182d and/or the adhesive layers 190, in combination, form the dielectric material 133 of the structure 100 of FIGS. 1A1-1D4.

In one embodiment, one of the metal layers 184a or 186a may be appropriately patterned, to form the upper plate 114 of the structure 100; and the other of the metal layers 184a or 186a may be at least partially or fully removed (e.g., etched away). For example, the metal layer 184a is appropriately patterned to form the upper plate 114 of the structure 100 (e.g., as illustrated in FIG. 1F). In such an example, the metal layer 186a may be at least partially or fully removed or etched away.

In one embodiment, one of the metal layers 184b or 186b may be appropriately patterned, to form the plate 106 of the component 110 of the structure 100; and the other of the metal layers 184b or 186b may be at least partially or fully removed (e.g., etched away). For example, the metal layer 184b is appropriately patterned to form the plate 106 of the structure 100 (e.g., as illustrated in FIG. 1F). In such an example, the metal layer 186b may be at least partially or fully removed or etched away.

In one embodiment, one of the metal layers 184c or 186c may be appropriately patterned, to form the signal line 120 of the structure 100; and the other of the metal layers 184c or 186c may be at least partially or fully removed (e.g., etched away). For example, the metal layer 184c is appropriately patterned to form the signal line 120 of the structure 100 (e.g., see FIG. 1F), and the metal layer 186c is at least partially or fully removed.

In one embodiment, one of the metal layers 184d or 186d may be appropriately patterned, to form the lower plate 116 of the structure 100; and the other of the metal layers 184d or 186d may be at least partially or fully removed (e.g., etched away) or kept as in (e.g., is non-functional). In some examples, the metal layer 184d is appropriately patterned to form the lower plate 116 of the structure 100, and the metal layer 186d is either at least partially or fully removed, or is not removed.

In one such example, the metal layer 186d is not removed, but is non-functional, e.g., doesn't provide any functionality to the operation of the resonator structure 100. In such an example, the metal layer 186d is not removed, and may provide structural support and rigidity to the structure 100. Thus, in such an example, the vias 104 and/or the post 108 extend from the metal layer 186d, through the patterned metal layer 184d (e.g., where the patterned metal layer 184d form the lower plate 116), and extend upwards toward the upper metal plate 114. Thus, in such an example, there is a metal layer 186d below and in parallel with the lower plate 116, and the vias 104 and post 106 extend downward through the lower plate 116 and up to the metal layer 186d, e.g., as illustrated in the example of FIG. 1F.

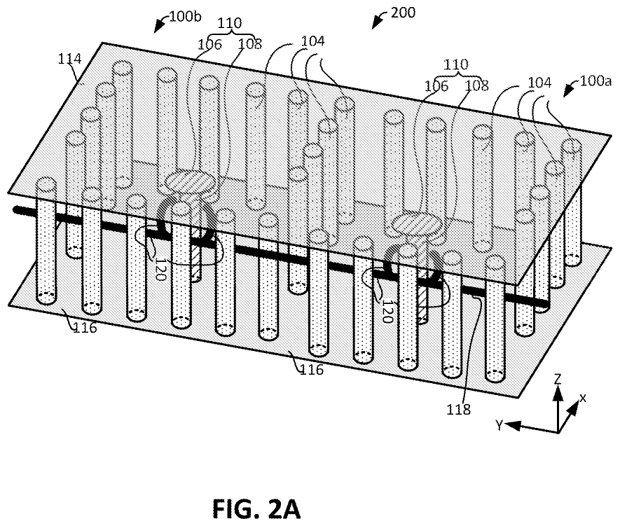

FIGS. 2A and 2B illustrate various views of an example filter structure 200 that is a combination of a first bandstop resonator structure 100a and a second bandstop resonator structure 100b, where each of the first and second bandstop resonator structures 100a, 100b is similar to the bandstop resonator structure 100 of FIGS. 1A1-1D4, in accordance with an embodiment of the present disclosure. FIG. 2A illustrates a perspective view of the filter structure 200 (also referred to herein as structure 200) and FIG. 2B illustrates a plan view of the structure 200. Note that in the plan view of FIG. 2B, the upper plate 114 is not illustrated.

Similar components within the structures 100a, 100b are labelled using the same labels that are also used for the structure 100 of FIGS. 1A1-1D4. For example, each resonator structure 100a, 100b comprises corresponding conductive component 110 including the post 108 and the plate 106. Furthermore, each resonator structure 100a, 100b comprises corresponding vias 104 extending from the lower plate 116 to the upper plate 114. As illustrated in FIGS. 2A and 2B, the structure 200 comprises a common upper plate 114 and a common lower plate 116 for both structures 100a and 100b. Each of structures 100a and 100b comprises a corresponding cavity defined by the upper plate 114, the lower plate 116, and the vias 114 forming the sidewalls (although the sidewalls are not continuous, as there are openings within the sidewalls comprising the vias 114). Also, the sidewall between the two cavities include a wall of vias 104n (see FIG. 2B) that are common to both the structures 100a and 100b. Thus, a single line of vias 104n (see FIG. 2B) is laterally between the plates 106 of the two structures 100a, 100b, in an example.

As also illustrated in FIGS. 2A and 2B, the structure 200 comprises the signal line 120 that is a continuous signal line extending through both the structures 100a and 100b. For example, the signal line 120 has a straight component 118 extending through openings between the vias 104 and through the structures 100a and 100b.

Furthermore, for each structure 100a, 100b, corresponding components 119a, 119b extend from the component 120 and at least in part wraps around the corresponding post 108. For example, as illustrated in FIG. 2B, in the structure 100a, components 119aa and 119ba extend from the component 120 and at least in part wraps around the corresponding post 108. Similarly, in the structure 100b, components 119ab and 119bb extend from the component 120 and at least in part wraps around the corresponding post 108.

In some examples, the resonator characteristics of the two resonator structures 100a, 100b may be different. For example, the first bandstop resonator structure 100a may have a resonant frequency, and the second bandstop resonator structure 100b may have another resonant frequency, where the resonant frequencies of the two resonator structures 100a, 100b may be different. In some such examples, to achieve the differences in the resonant frequencies of the two resonator structures 100a, 100b, one or more components of the two resonator structures 100a, 100b may be structured differently.

In some such examples, the components 119aa, 119ba of the structure 100a may be different from the corresponding components 119ab, 119bb of the structure 100b. For example, the components 119aa, 119ba of the structure 100a wrap the post 108 of the structure 100a relatively more than the wrapping of the post 108 of the structure 100b by the components 119ab, 119bb. Thus, in the example of FIG. 2B, the differences in the resonant frequencies of the two resonator structures 100a, 100b can be at least in part achieved by designing the wrapping of these components differently.

FIGS. 2A, 2B illustrate the structure 200 comprising two resonator structures 100a, 100b. However, in another example, more than two such resonator structures may be combined, where such combined resonator structures share a common and continuous upper plate 114, and a common and continuous lower plate 116.

FIGS. 3A1, 3A2, 3B1, 3B2, 3C1, 3C2, 3D1, 3D2, 3D3, 3D4, and 3E illustrate various views of an example resonator structure 300, where the resonator structure 300 may be used as a bandpass filter, in accordance with an embodiment of the present disclosure.

FIG. 3A1 illustrates a perspective of the resonator structure 300 (also referred to herein as “structure 300”), with the upper plate 114 of the structure 300 illustrated as being semitransparent (e.g., similar to FIG. 1A1). FIG. 3A2 the perspective of the resonator structure 300, without illustrating the upper plate 114.

FIG. 3B1 illustrates a cross-sectional view of the structure 300, e.g., along line AA-AA′ of FIG. 3A1. FIG. 3B2 illustrates another cross-sectional view of the structure 300 along line AA-AA′ of FIG. 3A1, but without illustrating one or more vias (such as vias 104a, 104b) of the structure 300 (e.g., similar to FIG. 1B2).

FIG. 3C1 illustrates a cross-sectional view of the structure 300, e.g., along line BB-BB′ of FIG. 3A1. FIG. 3C2 illustrates another cross-sectional view of the structure 300 along line BB-BB′ of FIG. 3A1, but without illustrating the vias 104 of the structure 300 (e.g., similar to FIG. 1C2).

FIGS. 3D1, 3D2, 3D3, and 3D3 illustrate various example cross-sectional views of the structure 300, e.g., along line CC-CC′ of FIG. 3B1. Thus, FIGS. 3D1, 3D2, 3D3, and 3D3 illustrate example plan views of the structure 300, without illustrating the upper plate 114. FIG. 3F illustrates a cross-section view that is similar to the cross-section view of FIG. 3B1.

The structure 300 of FIGS. 3A1-3D3 are at least in part similar to the structure 100 of FIGS. 1A1-1D4. For example, similar to the upper and lower plates 114, 116 of the structure 100 of FIGS. 1A1-1D4, the structure 300 comprises upper plate 314 and lower plate 316. Also, similar to the vias 104 of the structure 100 of FIGS. 1A1-1D4, the structure 300 comprises vias 304 extending from the lower plate 316 to the upper plate 314. Furthermore, similar to the component 110 of the structure 100 of FIGS. 1A1-1D4, the structure 300 comprises component 310 comprising a central post 308 extending upward from the lower plate 316 towards the upper plate 314, and an inner or central plate 308 above the post 308. Various discussions with respect to these components (such as the plates 114, 116, vias 104, and the component 110 including the post 108 and plate 106) of the structure 100 apply to the corresponding components (such as the plates 314, 316, vias 304, and the component 310 including the post 308 and plate 306) of the structure 300 of FIGS. 3A1-3D4.

The various dimensions H1-H8 and D1 of FIGS. 1B1-1C2 are replaced by corresponding dimensions H′1-H′9 and D′1 in FIGS. 3B1-3C2. In an example, the dimensions H′1-H′9 and D′1 of FIGS. 3B1-3C2 may be similar to, or different from, the dimensions H1-H9 and D1, respectively, of FIGS. 1B1-1C2. In an example, the dimensions may be appropriately tuned to achieve a desired resonance frequency of the resonator structure 300.

In one embodiment, the structure 300 comprises signal line 320, which has a different shape compared to the signal line 120 of the structure 100. For example, the structure 300 further comprises the signal line 320 traversing from one end of the structure 300 to a mid-section of the structure 300. For example, the signal line 320 terminates within the resonator structure 300. The signal line 320 comprises conductive material, such as one or more metals (e.g., copper) and/or alloys thereof.

As illustrated in FIGS. 3A1-3D4, the signal line 320 extends between the upper plate 314 and the lower plate 316. For example, the signal line 320 is substantially parallel to one or both the upper plate 314 and the lower plate 316 (note that the upper plate 314 and the lower plate 316 are parallel to each other in some examples).

In an example, the signal line 320 extends from a first end of the structure 300 to a mid-section of the structure 300, and does not exit the structure 300 from an opposing second end. Thus, the signal line 320 extends through an opening between two vias on the first end of the structure 300, and terminates within the resonator 300.

As illustrated in FIGS. 3B1, 3B2, 3C1, and 3C2, the signal line 320 is at a horizontal plane that is at a lower level than a horizontal plane of the plate 306. For example, at least a part of (or an entirety) of the signal line 320 extends within a first horizontal plane, at least a part of (or an entirety) the plate 306 extends within a second horizontal plane, where the second horizontal plane is above the first horizontal plane. For example, the second horizontal plane is closer to the upper plate 314 than the first horizontal plane. Thus, the plate 306 is closer to the upper plate 314 than the signal line 320. Similarly, the plate 306 is farther from the lower plate 316 than the signal line 320.

As illustrated in FIGS. 3D1-3D4, the signal line 320 has multiple components. For example, a component 317 of the signal line 320 is substantially straight, and extends from one end of the structure 300 (e.g., extends through the opening between two adjacent vias) to near a mid-section of the structure 300.

The signal line 320 further comprises a component 319 at least in part wrapping around the post 308, and another component 318 conjoining the components 317 and 319. As the component 319 extends from the component 118, the component 319 is also referred to herein as an extension component, or an extension, or a stub of the signal line 320. FIGS. 3D1, 3D2, 3D3, and 3D4 respectively illustrate four example configurations of the signal line 320.

For example, in FIG. 3D1, the component 319 is not below the plate 306. As illustrated in FIG. 3D1, the component 319 extends from the component 318 and at least in part wraps around the post 308.

In the example of FIG. 3D2, or at least a section of the components 318, 319 are below the plate 306. For example, an entirety of the component 319 is below the plate 306, and hence, the component 319 is illustrated using dotted line in FIG. 3D2. It may be noted that as discussed herein above, the signal line 320 is at a horizontal plane that is at a lower level than a horizontal plane of the plate 306. As illustrated in FIG. 3D2, the component 319 extends from the component 318 and at least in part wraps around the post 308.

In the example of FIG. 3D3, a wrapping of the component 319 around the post 308 is relatively less (e.g., less than the examples illustrated in FIGS. 3D1, 3D2, and 3D4). Thus, a length of the component 319 in FIG. 3D3 is less than that of FIGS. 3D1, 3D2, and 3D4.

In the example of FIG. 3D4, the component 319 fully wraps around or encircles the post 308. Although in this example the plate 308 (or the post 306) and the component 319 are not concentric, in another example, the post 306 and the component 309 may be concentric, e.g., which may be possible by appropriately spacing the component 319 of the signal line 320 with respect to post 306 and the plate 308.

In an example, similar to the structure 100, a cavity is defined in the structure 300, where the wall comprising the vias 304 defines sidewalls of the cavity, and the upper plate 314 and the lower plate 316 define upper and lower surfaces of the cavity. Thus, a cavity resonator is formed by the structure 300.

In an example, due to presence of the post 308 and the plate 306 at or near a center of the cavity, the cavity resonator is an evanescent-mode cavity resonator structure. As illustrated, the sidewalls of the cavity of the structure 300 are not solid wall-rather, the walls comprise the vias 104 having gaps therewithin (such as a gap between two adjacent vias 304a and 304b). A gap between two adjacent vias is configurable, and may be altered, e.g., to tune cutoff frequencies and/or resonance frequency of the resonator structure 300.

The structure 300 is loaded with an effective inductor and capacitor structure comprising the central component 310 (e.g., including the post 308 and the plate 306). The post 308 forms an inductance proportional to its height H′2 and/or inversely proportional to its diameter D′1 (see FIG. 3B2). The plate 306 forms a parallel plate capacitance with the upper plate 314. In an example, increasing the inductance and/or capacitance may reduce the cavity's resonant frequency, leading to a smaller size of the structure for a given resonant frequency.

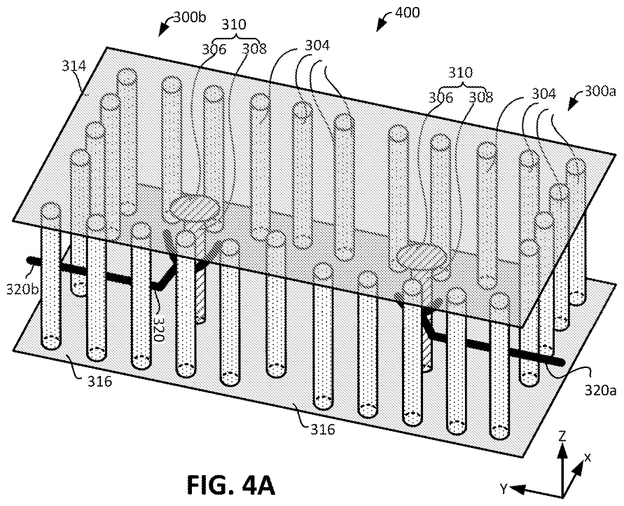

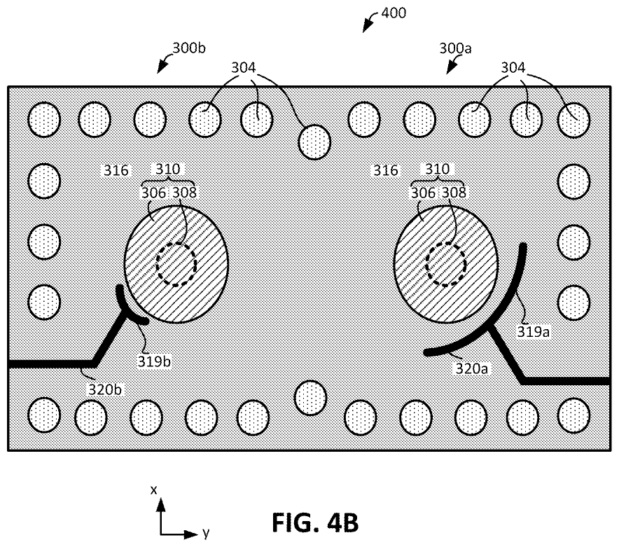

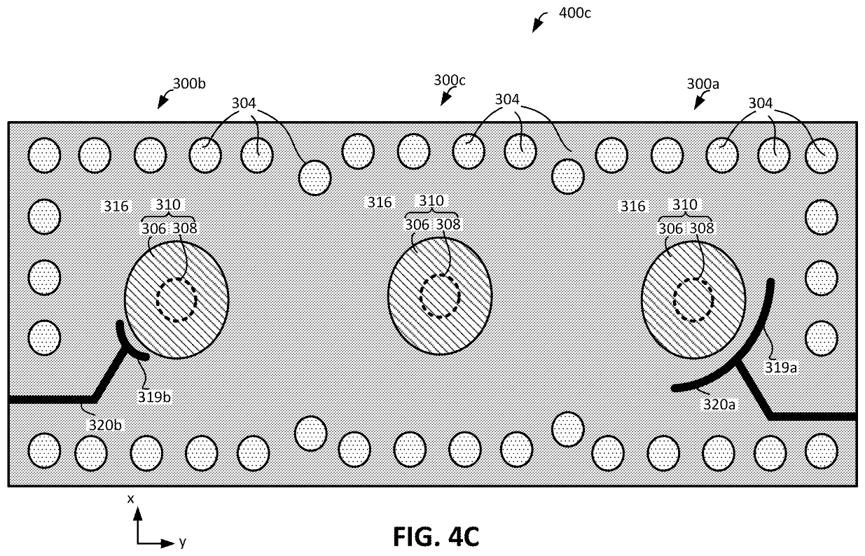

As illustrated in FIGS. 3A1-3D4, the signal line 320 is part of a source-to-load transmission line (the signal line 320 will be discussed herein further with respect to FIGS. 4A-4B). The source-to-load signal line 320 has the stub or extension component 319 at least in part wrapping around the central post 308 of the structure 300. The magnetic field of the extension component 319 couples with the magnetic field of the vias 304 and the component 310 (e.g., comprising the post 308 and the plate 306). Thus, as a signal passes through the signal line 320 of the resonator structure 300, the signal (e.g., energy of the signal) transmitted over the signal line 320 couples to the resonator structure 300 (e.g., couples to the vias 304 and the component 310), to form a bandpass filter.

In an example, a length of the extension component 319 may determine a strength of the coupling between the signal line 320 and the resonator structure 300. For example, the more the signal line 320 wraps around the post 308, the more tightly is the signal line 320 coupled to the resonator structure 300.

For example, the wrapping and/or the length of the extension component 319 may be altered, to achieve a desired filter transfer function. Thus, the wrapping and/or the length of the extension component 319 in the four example scenarios depicted in FIGS. 3D1-3D4 are all different, and hence, the filter transfer function achieved in FIGS. 3D1-3D4 are all correspondingly different.

In an example, the structure 300 is substantially enclosed by the upper and lower plates 314, 316, as well as the fence like cavity walls comprising the vias 304. This results in reduced radiation losses and coupling to nearby devices, in an example.

As discussed herein, a resonance frequency of the structure 300 may be tuned, e.g., by selecting the various dimensions illustrated in FIGS. 3B1-3C2. In an example, the resonator structure 300 may achieve a resonance frequency that is within RF range, such as within a range of 5 GHz to 30 GHz, such as in a subrange of 5 GHz to 20 GHz, or 5 GHz to 10 GHz, or 10 GHz to 30 GHz, or 10 GHz to 20 GHz, for example. In an example, a dimension H′9 (see FIG. 3B1) may be related to the resonance frequency λ as follows: H1≈N/7.5 mm. For example, for 20 GHz resonance frequency, the height H′9≈15/7.5 mm, e.g., 2 mm.

As discussed herein above, the resonator structure 300 acts as a bandpass filter, and the resonant frequency of the bandpass filter may be tuned by, for example, tuning the various dimensions illustrated in FIGS. 3B1-3D4, and/or by controlling the extent of wrapping of the post 108 by the extension component 319 of the signal line 320. Testing has shown that the resonator structure 300 may achieve high quality factor, such as quality factor of at least 100, or at least 200, or at least 300, or at least 400, or at least 500, or at least 700, or at least 1000, or at least 1500, or at least 1700, or at least 2000.

Similar to the structure 100 of FIG. 1, in an example, the structure 300 is a printed circuit board (PCB) based structure comprising a vertical stack of PCBs, such as the stack illustrated in FIG. 1E herein above. Thus, the discussion of the structure 100 with respect to FIGS. 1E and 1F may also apply to the structure 300 of FIGS. 3A1-3D4. Accordingly, similar to FIGS. 1E and 1F, the structure 300 may include a metal layer 386d that is below and in parallel with the lower plate 316, and the vias 304 and post 306 extends downward through the lower plate 316 and up to the metal layer 386d, e.g., as illustrated in the example of FIG. 3E.

FIGS. 4A and 4B illustrate various views of an example filter structure 400 that is a combination of a first bandpass resonator structure 300a and a second bandpass resonator structure 300b, where each of the first and second bandpass resonator structures 300a, 300b is at least in part similar to the bandpass resonator structure 300 of FIGS. 3A1-3D4, in accordance with an embodiment of the present disclosure. FIG. 4A illustrates a perspective view of the filter structure 400 (also referred to herein as structure 400) and FIG. 4B illustrates a plan view of the structure 400. Note that in the plan view of FIG. 4B, the upper plate 314 is not illustrated.

Similar components within the structures 300a, 300b are labelled using the same labels that are also used for the structure 300 of FIGS. 3A1-3D4. For example, each resonator structure 300a, 300b comprises corresponding conductive component 310 including the post 308 and the plate 306. Furthermore, each resonator structure 300a, 300b comprises corresponding vias 304 extending from the lower plate 316 to the upper plate 314. As illustrated in FIGS. 4A and 4B, the structure 400 comprises a common upper plate 414 and a common lower plate 416 for both structures 400a and 400b. Each of structures 400a and 400b comprises a corresponding cavity defined by the upper plate 314, the lower plate 316, and the vias 314 forming the sidewalls (although the sidewalls are not continuous, as there are openings within the sidewalls comprising the vias 314).

Also, as illustrated more prominently in the plan view of FIG. 4B, the two cavities of the two structures 300a and 300b are conjoined, due to a lack of one or more vias 304 laterally between the posts 308 of the two structures 300a, 300b. Because of the joining of the two cavities of the two structures 300a and 300b, the two structures 300a and 300b may be inductively or electromagnetically coupled to each other.

As also illustrated in FIGS. 4A and 4B, the structure 300a comprises the signal line 320a extending from one end of the structure 300a and terminating within the structure 300a. Similarly, the structure 300b comprises the signal line 320b extending from one end of the structure 300b and terminating within the structure 300b. Thus, there is no continuous signal line conjoining the signal lines 320a and 320b, and the signal lines 320a and 320b are not in physical contact with each other. Rather, in an example, the signal lines 320a, 320b are inductively or electromagnetically coupled through the corresponding components of the two structures 300a, 300b.

In some examples, the frequency characteristics of the two resonator structures 300a, 300b may be different. For example, the first bandpass resonator structure 300a may have a resonant frequency, and the second bandpass resonator structure 300b may have another resonant frequency, where the resonant frequencies of the two resonator structures 300a, 300b may be different from each other.

In some such examples, to achieve the differences in the resonant frequencies of the two resonator structures 300a, 300b, one or more components of the two resonator structures 300a, 300b may be structured differently. In some such examples, the components 319a and 319b of the signal lines 320a, 320b, respectively, of the structures 300a, 300b, respectively, have different profiles, as illustrated in FIG. 4B. For example, the component 319a of the structure 300a wraps the post 308 of the structure 300a relatively more than the wrapping of the post 308 of the structure 300b by the component 319b. The difference in the wrapping of the components 319a, 319b of the respective posts 310 of the structures 300a, 300b, respectively, may result in different resonance frequencies and/or cutoff frequencies of the structures 300a, 300b, in an example. Accordingly, the resonance frequencies and/or cutoff frequencies of the structures 300a, 300b may be tuned by, for example, appropriately designing the components 319a, 319b, an example of which is illustrated in FIG. 4B.

FIGS. 4A, 4B illustrate the structure 400 comprising two resonator structures 300a, 300b. However, in another example, more than two such resonator structures may be combined, where such combined resonator structures share a common and continuous upper plate 314, and a common and continuous lower plate 316.

FIG. 4C illustrate a plan view of another example filter structure 400c that is a combination of a first bandpass resonator structure 300a, a second bandpass resonator structure 300b, and a third bandpass resonator structure 300c, where each of the first, second, and third bandpass resonator structures 300a, 300b, 300c is at least in part similar to the bandpass resonator structure 300 of FIGS. 3A1-3D4, in accordance with an embodiment of the present disclosure. FIG. 4C illustrates a plan view of the structure 400c. Note that in the plan view of FIG. 4C, the upper plate 314 is not illustrated, similar to the view of FIG. 4B.

As illustrated, in the example of FIG. 4C, the structure 300c is laterally between the structures 300a and 300b. In one embodiment, the signal lines 320a and 320b of the structures 300a, 300b, respectively, terminate within the structures 300a, 300b. There is no signal line for the structure 300c. The structure 300c inductively or electromagnetically couples the structures 300a, 300b (e.g., indicatively or electromagnetically couples the signal lines 330a, 320b). Thus, there are three bandpass resonator structures in the structure 400c of FIG. 4C. Signal between the signal lines 320a and 320b are inductively or electromagnetically transmitted, e.g., through the resonator structure 300c.

FIGS. 5A and 5B illustrate an example filter structure 500 that is a combination of a plurality of bandpass resonator structures 300a, 300b, 300c and a plurality of bandstop resonator structures 100a, 100b, where each of the plurality of bandpass resonator structures 300a, 300b, 300c is at least in part similar to the bandpass resonator structure 300 of FIGS. 3A1-3D4, and where each of the plurality of bandstop resonator structures 100a, 100b is at least in part similar to the bandstop resonator structure 100 of FIGS. 1A1-1D4, in accordance with an embodiment of the present disclosure. FIG. 5A illustrates a schematic representation of the filter structure 500 in which the bandpass filters or resonators 300a, 300b, 300c are schematically illustrated using oval having lines therewithin, and bandstop filters or resonators 100a, 100b are schematically illustrated using oval without any lines therewithin.

In the filter structure 500, the two bandstop resonator structures 100a, 100b are adjacent to each other, and the three bandpass resonator structures 300a, 300b, 300c are adjacent to each other, although this may not necessarily be the case. Transmission lines 502a, 502b (e.g., which are extension of the signal lines between two resonator structures) are also illustrated in FIG. 5A. The filter structure 500 will be apparent, based on the discussion of the structures 200, 400, and 400c discussed with respect to FIGS. 2A, 2B, and 4A-4C. Note that a common upper plate 114 and a common lower plate 116 is used for the structure 500.

In an example, filter designs may incorporate transmission zeros (TZs) into the filter's transfer function, e.g., to increase a selectivity of the filter. Transmission zeros represent finite, nonzero frequencies at which the filter exhibits (e.g., at least ideally exhibits) infinite attenuation. Such finite zeros increase a steepness of the filter's passband-to-stopband transition, e.g., at an expense of ripples in the stopband attenuation.

In a coupled-resonator filter, transmission zeros may be implemented by introducing cross-couplings into the filter coupling routing structure. In an example, such cross-coupling elements may be relatively difficult to implement, e.g., as such cross-coupling elements may use 3-dimensional structures.

In an example, another class of filters may present an alternative way (e.g., instead of using cross-couplings) of implementing transmission zeros. For example, filters based on extracted-pole architectures may achieve similar frequency responses to coupled-resonator topologies, but may not use opposite-valued cross coupling elements. Instead, filters based on extracted-pole architectures may realize transmission zeroes through the use of bandstop and/or bandpass configured resonator structures, such as the bandstop and bandpass resonator structures discussed herein above with respect to FIGS. 1A-5B.

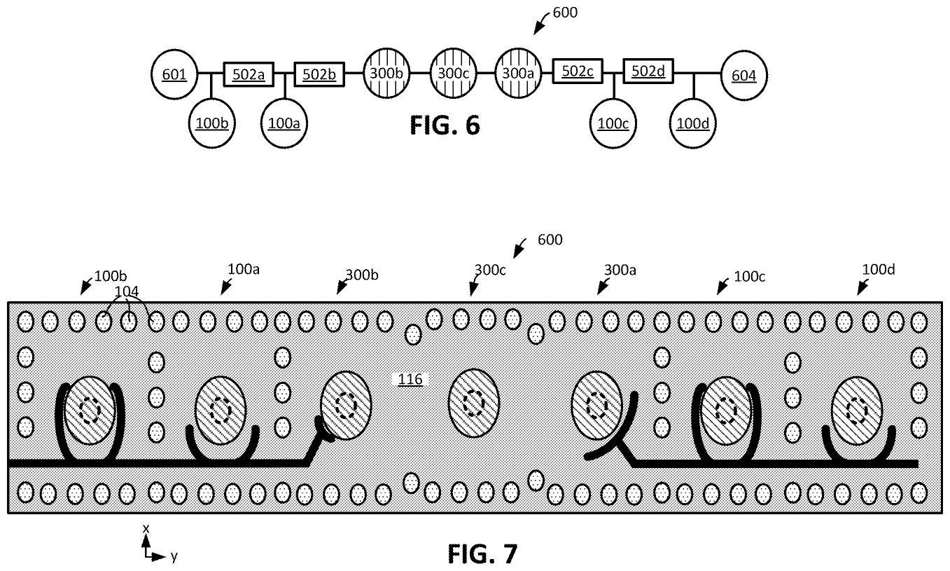

FIG. 6 illustrates an N^{th} order (where N=7 in the example of FIG. 6) extracted-pole filter 600 implemented using a plurality of bandstop resonator structures 100a, 100b, 100c, 100d (e.g., each of which is at least in part similar to the resonator structure 100 discussed with respect to FIGS. 1A-1D4) and a plurality of bandpass resonator structures 300a, 300b, 300c (e.g., each of which is at least in part similar to the resonator structure 300 discussed with respect to FIGS. 3A-3D4), in accordance with an embodiment of the present disclosure. Of the N total resonators (e.g., 7 in this case), some resonator structures (such as M resonator structures, where M=4 in the example of FIG. 6) are implemented as bandstop-configured resonators 100a, . . . , 100d connected with lengths of transmission line to implement M transmission zeros. The remaining (N-M) (where N-M is 3 in the example of FIG. 6) resonator structures 300a, . . . , 300c may be implemented using bandpass-configured resonators. Also included in FIG. 6 are the source 601 and load 604 on two ends of the filter 600. The filter 600 may can realize up to (N−1) transmission zeros, e.g., without using any cross-coupling elements.

FIG. 7 illustrates implementation of the example seventh order filter 600 of FIG. 6, where the filter 600 is a combination of a plurality of bandpass resonator structures 300a, 300b, 300c and a plurality of bandstop resonator structures 100a, 100b, 100c, 100d, where each of the plurality of bandpass resonator structures 300a, 300b, 300c is at least in part similar to the bandpass resonator structure 300 of FIGS. 3A1-3D4, and where each of the plurality of bandstop resonator structures 100a, 100b, 100c, 100d is at least in part similar to the bandstop resonator structure 100 of FIGS. 1A1-1D4, in accordance with an embodiment of the present disclosure. Note that a common upper plate 114 and a common lower plate 116 is used for the structure 600. The filter structure 700 will be apparent, based on the discussion of the structures 200, 400, 400c, and 500 discussed with respect to FIGS. 2A, 2B, 4A-4C, and 5A-5B herein above.

### Filter and Resonator Structure Calibration

Manufacturing processes, such as those employed to manufacture the bandpass and/or bandstop resonator structures discussed herein, may have some random variations, e.g., due to limitations in the manufacturing processes. Such manufacturing variations may be problematic in some filters, such as narrowband filters, e.g., which may have relatively stringent passband insertion loss and stopband rejection requirements with relatively narrow range of frequencies allowed to transition between passband and stopband. Accordingly, in some examples, frequency-tuning mechanisms may be adapted, e.g., by patterning specific features in the upper plate 114 (or 314) of the resonator structure, to tune the resonance frequencies.

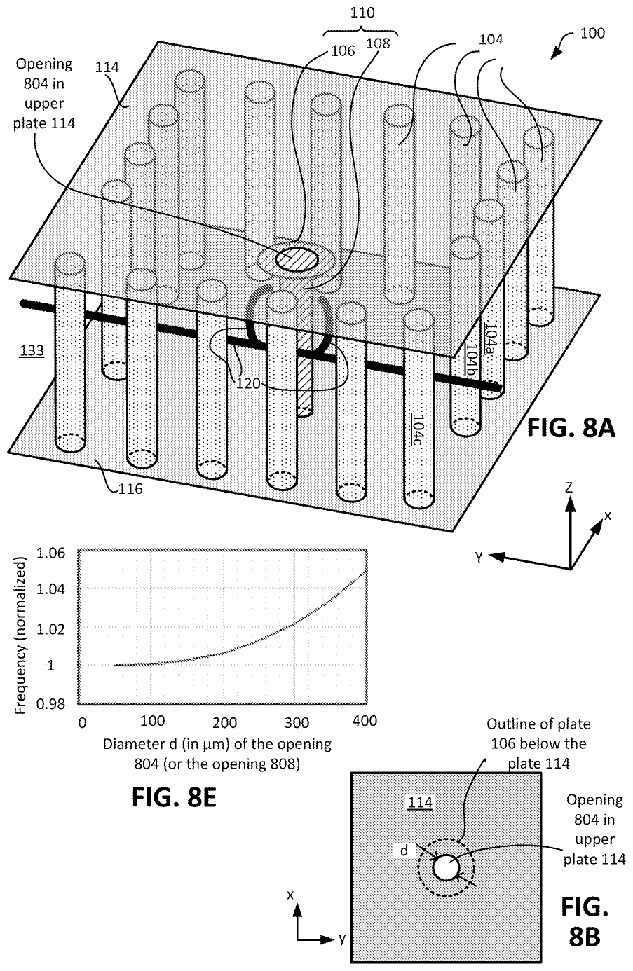

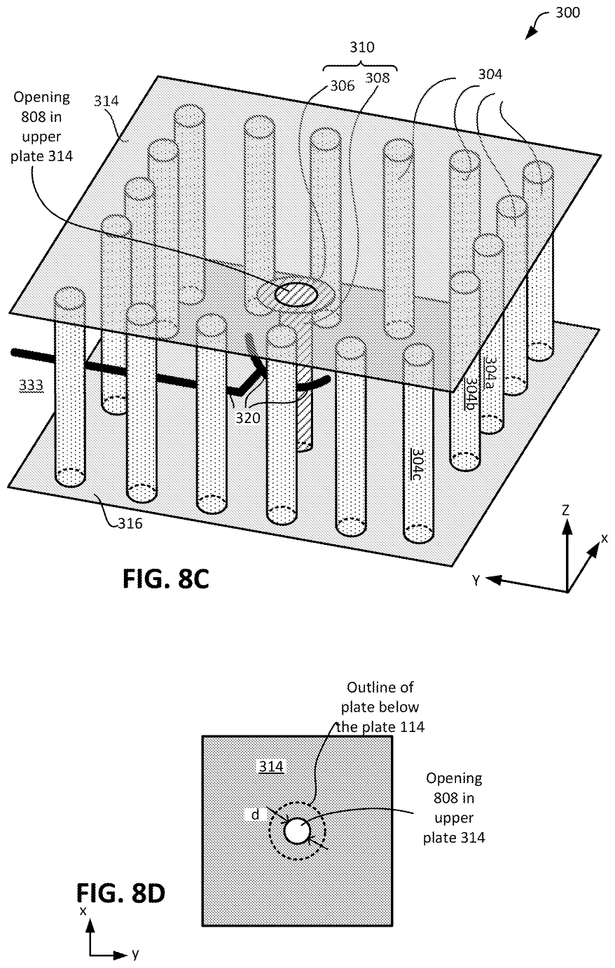

FIGS. 8A and 8B illustrate an opening 804 on the upper plate 114 of a bandstop resonator structure 100 of FIGS. 1A1-1D4, to increase a resonance frequency of the bandstop resonator structure 100, in accordance with an embodiment of the present disclosure. FIGS. 8C and 8D illustrate an opening 808 on the upper plate 314 of a bandpass resonator structure 300 of FIGS. 3A1-3D4, to increase a resonance frequency of the bandpass resonator structure 300, in accordance with an embodiment of the present disclosure. FIG. 8E illustrates an effect of the openings of any of FIGS. 8A-8D on a resonance frequency of the corresponding resonator structure, in accordance with an embodiment of the present disclosure.

FIGS. 8A and 8C illustrate perspective views of the corresponding resonator structures 100 and 300, respectively. FIGS. 8B and 8D illustrate plan views of the upper plate of the corresponding resonator structures 100 and 300, respectively. An outline of the plate 106 (which is below the upper plate) is also illustrated in each of FIGS. 8B and 8D.

Referring to FIGS. 8A and 8B, in the resonator structure 100, the opening 804 is formed within the upper plate 114, e.g., directly above the plate 106. Although FIGS. 8A and 8B illustrate a circular opening, in an example, the opening 804 can be of any appropriate shape, such as square, rectangle, oval, or another appropriate shape. In an example, the opening 804 reduces surface area of the upper plate 114 above the plate 106, and hence, reduces the effective capacitance between the plates 106 and 114. This results in an increase in a resonance frequency of the resonator structure 100.

Similarly, referring to FIGS. 8C and 8D, in the resonator structure 300, the opening 808 is formed within the upper plate 314, e.g., directly above the plate 106. Although FIGS. 8C and 8D illustrate a circular opening, in an example, the opening 808 can be of any appropriate shape, such as square, rectangle, oval, or another appropriate shape. In an example, the opening 808 reduces surface area of the upper plate 314 above the plate 106, and hence, reduces the effective capacitance between the plates 106 and 314. This results in an increase in a resonance frequency of the resonator structure 300.

In one embodiment, the openings 804 and/or 808 may be formed using an appropriate technique to form an opening within a conductive plate (such as the plate 114, 314). Examples of such techniques include mechanical milling, laser ablation, chemical etching, or another appropriate metal removal technique.

Referring now to FIG. 8E, the X axis of the graph depicts a diameter d (in micrometer or μm) of the opening 804 (or the opening 808), and the Y axis represents a normalized frequency of the corresponding resonator structure 100 or 300. As illustrated, an increase in the diameter d of the opening results in a corresponding non-linear increase in the resonance frequency of the resonator structure 100 or 300, in an example.

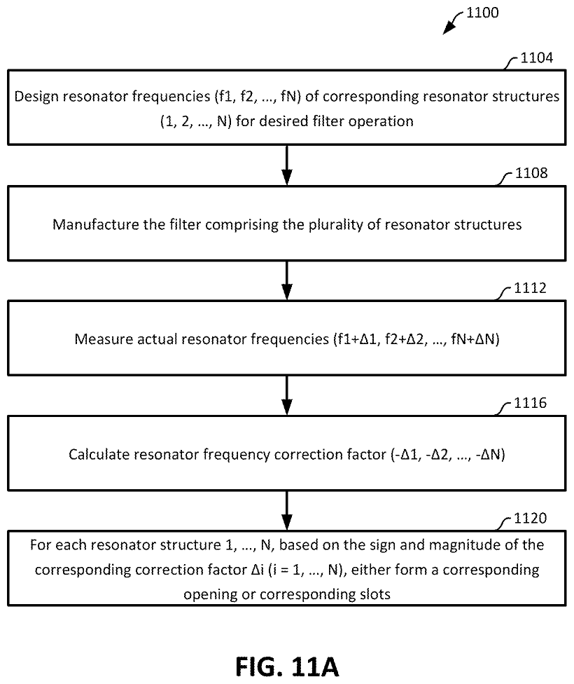

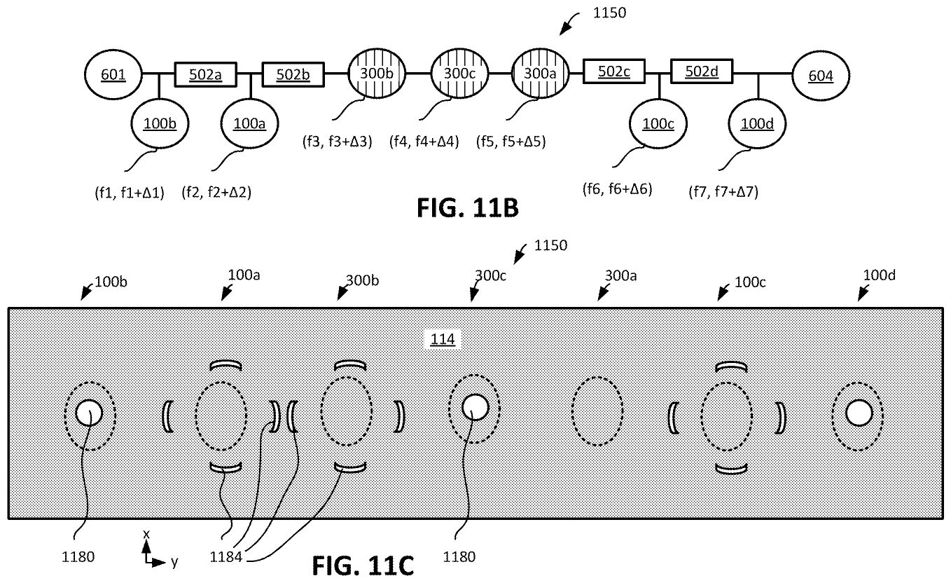

For example, as will be discussed in further detail with respect to FIG. 11A herein later, after formation of a resonator structure, a resonance frequency and/or other frequencies of interest (e.g., cutoff frequencies) are measured, and it is determined as to whether the frequency of the resonator structure is to be increased. If the frequency of the resonator structure is to be increased, then it is determined as to how much the frequency is to be increased. Furthermore, the desired increase in frequency is correlated to a target diameter d of the opening, where the target diameter d of the opening may result in the desired increase in the frequency (e.g., see FIG. 8E). Subsequently, the opening 804 for the resonator structure 100 (or the opening 808 for the resonator structure 300) is formed within the upper plate of the resonator structure.

FIGS. 9A and 9B illustrate openings or slots 904 on the upper plate 114 of a bandstop resonator structure 100 of FIGS. 1A1-1D4, to decrease a resonance frequency of the bandstop resonator structure 100, in accordance with an embodiment of the present disclosure. FIGS. 9C and 9D illustrate openings or slots 908 on the upper plate 314 of a bandpass resonator structure 300 of FIGS. 3A1-3D4, to decrease a resonance frequency of the bandpass resonator structure 300, in accordance with an embodiment of the present disclosure. FIG. 9E illustrates an effect of the slots of any of FIGS. 8A-8D on a resonance frequency of the corresponding resonator structure, in accordance with an embodiment of the present disclosure.

FIGS. 9A and 9C illustrate perspective views of the corresponding resonator structures 100 and 300, respectively. FIGS. 9B and 9D illustrate plan view of only the upper plate of the corresponding resonator structures 100 and 300, respectively. An outline of the plate 106 (which is below the upper plate) is also illustrated in each of FIGS. 9B and 9D.

Referring to FIGS. 9A and 9B, the openings or slots 904 are formed within the upper plate 114, e.g., along or near the perimeter of the cavity of the resonator structure 100. The slots 904 force the current flowing on the surface of the upper plate 114 (e.g., top surface of the corresponding cavity) to travel a longer path, thereby increasing an effective inductance and consequently lowering the resonant frequency. As illustrated, in an example, the slots 904 are not above the plate 106, but rather on a section of the upper plate that is between the plate 106 and the vias 104.

Similarly, referring to FIGS. 9C and 9D, the opening or slots 908 are formed within the upper plate 314, e.g., along or near the perimeter of the cavity of the resonator structure 300. The slots 908 force the current flowing on the surface of the upper plate 314 (e.g., top surface of the corresponding cavity) to travel a longer path, thereby increasing an effective inductance and consequently lowering the resonant frequency. As illustrated, in an example, the slots 908 are not above the plate 306, but rather on a section of the upper plate that is between the plate 106 and the vias 104.

In one embodiment, the slots 904 and/or 908 may be formed using an appropriate technique to form an opening within a conductive plate (such as the plate 114, 314). Examples of such techniques include mechanical milling, laser ablation, chemical etching, or another appropriate metal removal technique.

Referring now to FIG. 9E, the X axis of the graph depicts a sweep angle of individual slots (see FIGS. 9B and 9D for the sweep angle), and the Y axis represents a normalized frequency of the corresponding resonator structure 100 or 300. As illustrated, an increase in the angle results in corresponding non-linear decrease in the frequency of the resonator structure 100 or 300, in an example.

For example, as will be discussed in further detail with respect to FIG. 11A, after formation of a resonator structure, a resonance frequency and/or other frequencies of interest (e.g., cutoff frequencies) are measured, and it is determined as to whether the frequency of the resonator structure is to be decreased. If the frequency of the resonator structure is to be decreased, then it is determined as to how much the frequency is to be decreased. Furthermore, the desired decrease in frequency is correlated to a target sweep angle of individual slot 904 or 908, where the target angle may result in the desired decrease in the frequency (e.g., see FIG. 9E). Subsequently, the slots 904 for the resonator structure 100 (or the slots 908 for the resonator structure 300) are formed within the upper plate of the resonator structure.

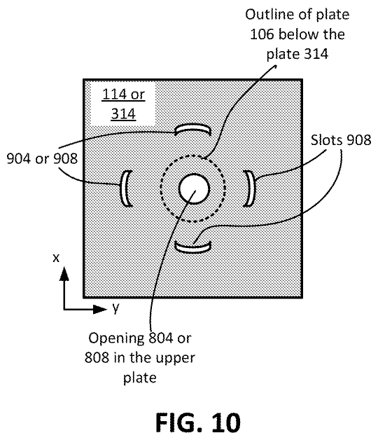

FIG. 10 illustrates both slots and openings within the upper plate of a resonator structure of any of FIGS. 1A1-3D4, to increase and/or decrease a resonance frequency of the resonator structure, in accordance with an embodiment of the present disclosure. Thus, in this figure, both slots and openings are formed within the upper plate. For example, if an increase of the frequency of the resonator structure is desired, the opening 804 (or 808) above the post 106 is formed. If the opening is made too large and the frequency increase is overcompensated, the frequency is to be decreased. This may be achieved by forming the slots 904 (or 908). Thus, in some such examples, both slots and openings may be formed within the upper plate of the resonator structure.

FIG. 11A illustrate a flowchart depicting a method 1100 for tuning a filter 1150 comprising a plurality of resonator structures, e.g., by selectively either forming slots or an opening (or neither slot nor opening) on sections of upper plate of individual resonator structures, in accordance with an embodiment of the present disclosure. FIGS. 11B and 11C illustrate the example filter 1150 of FIG. 11A after the tuning process, in accordance with an embodiment of the present disclosure.

At 1104 of the method 1100, target resonator frequencies f1, f2, . . . , fN of corresponding resonator structures 1, 2, . . . , N are designed, for desired operation of the filter 1150. For example, as illustrated in FIGS. 11B and 11C, the filter 1150 comprises N number of filters, where N=7 in the example of FIG. 11B. The filter 1050 of FIGS. 11B and 11C is similar to the filter 600 of FIGS. 6 and 7. For example, the resonator structures 100b, 110a, 300b, 300c, 300a, 100c, and 100d are respectively assumed to be filters 1, 2, . . . , N (where N=7). Accordingly, the resonator structures 100b, 110a, 300b, 300c, 300a, 100c, and 100d are designed for resonance frequencies f1, f2, . . . , f7.

Referring again to FIG. 11A, the method 1100 proceeds from 1104 to 1108, where the filter 1150 is manufactured, where the filter 1150 includes the plurality of resonator structures 1, . . . , N. In an example, the filter 1150 is manufactured from a vertical stack of PCBs, using one or more appropriate techniques, e.g., as discussed with respect to FIG. 11E herein above.

Referring again to FIG. 11A, the method 1100 proceeds from 1108 to 1112, where actual resonator frequencies (f1+Δ1, f2+Δ2, . . . , fN+ΔN) of the resonator structures (1, 2, . . . , N) are measured. The actual resonator frequencies may be measured from a frequency response plot of the filter 1150. Here Δi (where i=1, . . . , N) represents a difference between the actual frequency (fi+Δi) achieved for a manufactured i^{th} resonator structure and the corresponding designed frequency (fi) for the i^{th} resonator structure. In one embodiment where a specific resonator structure is manufactured exactly as designed, the corresponding difference Δ would be zero. However, because of unintentional manufacturing variability, the difference Δ for individual resonator structure may have a non-zero positive or negative value. For example, the difference Δ1 may be positive, the difference 42 may be negative, and so on.

Referring again to FIG. 11A, the method 1100 proceeds from 1112 to 1116, where the resonator frequency correction factors (−Δ1, −Δ2, . . . , −ΔN) are calculated, e.g., by calculating differences between the designed resonator frequencies (f1, f2, . . . , fN) and the measured resonator frequencies (f1+Δ1, f2+Δ2, . . . , fN+ΔN). Thus, the sign and magnitude of the difference Δ for each resonator structure is calculated.

Referring again to FIG. 11A, the method 1100 proceeds from 1116 to 1120, where for each resonator structure 1, . . . , N, based on the sign and magnitude of the corresponding correction factor Δi (i=1, . . . , N), either a corresponding opening or corresponding slots are formed (or neither is formed, e.g., if the corresponding A is substantially zero). For example, if the actual frequency of a first resonator structure is to be increased, an opening 804 or 808 is formed within the upper plate of the corresponding resonator structure (e.g., see graph of FIG. 8E). On the other hand, in an example, if the frequency of a second resonator structure is to be decreased, slots 904 or 908 are formed within the upper plate of the corresponding resonator structure (e.g., see graph of FIG. 9E).

As also discussed with respect to FIG. 8E, a diameter of the opening to be formed within the upper plate of the first filter is based on a magnitude of frequency to be increased. Similarly, as also discussed with respect to FIG. 9E, a sweep angle of the slots to be formed within the upper plate of the second filter is based on an amount of frequency to be decreased.

FIG. 11C illustrates example slots and openings within the upper plate 114 (here the same upper plate 114 is common for all the resonator structures 100a, . . . , 110d, 300a, . . . , 300c). As illustrated, openings 1080 are formed for the resonator structures 100b, 300c, and 100d, whereas slots 1184 are formed for the resonator structures 100a, 300b, and 100c. In an example, the difference Δ is substantially zero (or below a threshold value that represents an acceptable limit of error in the frequency) for the resonator structure 300a, and hence, no opening or slot is formed for this resonator structure.

### Further Example Embodiments

The following examples pertain to further embodiments, from which numerous permutations and configurations will be apparent.

Example 1. An apparatus comprising: a lower plate comprising conductive material; an upper plate comprising conductive material, the upper plate above the lower plate; a plurality of vias comprising conductive material extending from the lower plate to the upper plate; a post comprising conductive material extending from the lower plate and towards the upper plate; and an inner plate comprising conductive material above and in contact with the post, wherein the post and the inner plate are separated from the upper plate by dielectric material.

Example 2. The apparatus of example 1, wherein the plurality of vias are arranged to at least in part wrap around the post.

Example 3. The apparatus of any one of examples 1-2, further comprising: a signal line extending between the lower and upper plates, the signal line extending through an opening between a first via and a second via of the plurality of vias.

Example 4. The apparatus of example 3, wherein the signal line is substantially parallel to one or both the lower and upper plates.

Example 5. The apparatus of any one of examples 3-4, wherein: at least a part of the signal line extends within a first horizontal plane, at least a part of the inner plate extends within a second horizontal plane, and the second horizontal plane is closer to the upper plate than the first horizontal plane.

Example 6. The apparatus of any one of examples 3-5, wherein the signal line at least in part wraps around the post.

Example 7. The apparatus of any one of examples 3-7, wherein: the apparatus comprises a cavity defined by (i) the lower plate forming a lower surface of the cavity, (ii) the upper plate forming an upper surface of the cavity, and (iii) the plurality of vias forming walls of the cavity, with the post and the inner plate within the cavity; and the signal line comprises a first component (i) extending through the opening between the first via and the second via of the plurality of vias and entering the cavity, and (ii) extending through an opening between a third via and a fourth via of the plurality of vias and exiting the cavity, a second component extending from the first component, and a third component extending from the first component.

Example 8. The apparatus of example 7, wherein the second and third components, in combination, at least in part wraps around the post.

Example 9. The apparatus of any one of examples 7-8, wherein the upper and lower plates, the plurality of vias, the post, the inner plate, and the signal line form a bandstop resonator structure.

Example 10. The apparatus of any one of examples 3-9, wherein: the apparatus comprises a cavity defined by (i) the lower plate forming a lower surface of the cavity, (ii) the upper plate forming an upper surface of the cavity, and (iii) the plurality of vias forming walls of the cavity, with the post and the inner plate within the cavity; and the signal line comprises a first component (i) extending through the opening between the first via and the second via of the plurality of vias and entering the cavity, and (ii) terminating within the cavity, and a second component coupled to the first component, the second component at least in part wrapping around the post.

Example 11. The apparatus of example 10, wherein the upper and lower plates, the plurality of vias, the post, the inner plate, and the signal line form a bandpass resonator structure.

Example 12. The apparatus of example 1, wherein the plurality of vias is a first plurality of vias, the post is a first post, the inner plate is a first inner plate, and wherein the apparatus further comprises: a second plurality of vias comprising conductive material extending from the lower plate to the upper plate; a second post comprising conductive material extending from the lower plate and towards the upper plate; and a second inner plate comprising conductive material above and in contact with the second post, wherein the second post and the second inner plate are separated from the upper plate by the dielectric material, wherein the second plurality of vias are arranged to at least in part wrap around the second post.

Example 13. The apparatus of any one of examples 1-12, wherein: the upper plate has an opening that is at least in part above the inner plate.

Example 14. The apparatus of any one of examples 1-13, wherein: the apparatus comprises a cavity defined by (i) the lower plate forming a lower surface of the cavity, (ii) the upper plate forming an upper surface of the cavity, and (iii) the plurality of vias forming walls of the cavity, with the post and the inner plate within the cavity; and upper plate has one or more openings that are above the cavity, but not above the post or the inner plate.

Example 15. A method of tuning a filter structure comprising at least a first resonator and a second resonator, comprising: forming the filter structure that comprises an upper plate and a lower plate that are common to both first and second resonators, wherein the first resonator further comprises (i) a first post extending from the lower plate towards the upper plate, (ii) a first inner plate above the first post, and (iii) a first plurality of vias extending from the lower plate to the upper plate and arranged at least in part around the first post, and wherein the second resonator further comprises (i) a second post extending from the lower plate towards the upper plate, (ii) a second inner plate above the second post, and (iii) a second plurality of vias extending from the lower plate to the upper plate and arranged at least in part around the second post; forming a first opening within the upper plate and above the first post; and forming a second opening within a section of the upper plate, the section of the upper plate between the second post and the second plurality of vias.

Example 16. The method of example 15, wherein forming the first opening comprises: determining that the first resonator has a first resonance frequency that is lower than a first target frequency; and in response to determining that the first resonance frequency is lower than the first target frequency, forming the first opening within the upper plate and above the first post.

Example 17. The method of example 16, wherein forming the first opening comprises: prior to forming the first opening, calculating a target diameter of the first opening, based on a difference between the first resonance frequency and the first target frequency; and forming the first opening having the target diameter.

Example 18. The method of any one of examples 16-17, wherein forming the second opening comprises: determining that the second resonator has a second resonance frequency that is higher than a second target frequency; and in response to determining that the second resonance frequency is higher than the second target frequency, forming the second opening within the section of the upper plate that is between the second post and the second plurality of vias.

Example 19. A filter comprising at least a first resonator and a second resonator, the filter comprising: an upper plate and a lower plate that are common to both first and second resonators; wherein the first resonator further comprises (i) a first post extending from the lower plate towards the upper plate, (ii) a first inner plate above the first post, and (iii) a first plurality of vias extending from the lower plate to the upper plate and arranged at least in part around the first post; and wherein the second resonator further comprises (i) a second post extending from the lower plate towards the upper plate, (ii) a second inner plate above the second post, and (iii) a second plurality of vias extending from the lower plate to the upper plate and arranged at least in part around the second post.

Example 20. The filter of example 19, wherein: the upper plate comprises a first opening above the first post; and the upper plate comprises a second opening within a section of the upper plate that is between the second post and the second plurality of vias.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. An apparatus comprising:
a lower plate comprising conductive material;
an upper plate comprising conductive material, the upper plate above the lower plate;
a plurality of vias comprising conductive material extending from the lower plate to the upper plate;
a post comprising conductive material extending from the lower plate and towards the upper plate; and
an inner plate comprising conductive material above and in contact with the post, wherein the post and the inner plate are separated from the upper plate by dielectric material.

2. The apparatus of claim 1, wherein the plurality of vias are arranged to at least in part wrap around the post.

3. The apparatus of claim 1, further comprising:
a signal line extending between the lower and upper plates, the signal line extending through an opening between a first via and a second via of the plurality of vias.

4. The apparatus of claim 3, wherein the signal line is substantially parallel to one or both the lower and upper plates.

5. The apparatus of claim 3, wherein:
at least a part of the signal line extends within a first horizontal plane, at least a part of the inner plate extends within a second horizontal plane, and the second horizontal plane is closer to the upper plate than the first horizontal plane.

6. The apparatus of claim 3, wherein the signal line at least in part wraps around the post.

7. The apparatus of claim 3, wherein:
the apparatus comprises a cavity defined by (i) the lower plate forming a lower surface of the cavity, (ii) the upper plate forming an upper surface of the cavity, and (iii) the plurality of vias forming walls of the cavity, with the post and the inner plate within the cavity; and
the signal line comprises
a first component (i) extending through the opening between the first via and the second via of the plurality of vias and entering the cavity, and (ii) extending through an opening between a third via and a fourth via of the plurality of vias and exiting the cavity,
a second component extending from the first component, and
a third component extending from the first component.

8. The apparatus of claim 7, wherein the second and third components, in combination, at least in part wraps around the post.

9. The apparatus of claim 7, wherein the upper and lower plates, the plurality of vias, the post, the inner plate, and the signal line form a bandstop resonator structure.

10. The apparatus of claim 3, wherein:
the apparatus comprises a cavity defined by (i) the lower plate forming a lower surface of the cavity, (ii) the upper plate forming an upper surface of the cavity, and (iii) the plurality of vias forming walls of the cavity, with the post and the inner plate within the cavity; and
the signal line comprises
a first component (i) extending through the opening between the first via and the second via of the plurality of vias and entering the cavity, and (ii) terminating within the cavity, and
a second component coupled to the first component, the second component at least in part wrapping around the post.

11. The apparatus of claim 10, wherein the upper and lower plates, the plurality of vias, the post, the inner plate, and the signal line form a bandpass resonator structure.

12. The apparatus of claim 1, wherein the plurality of vias is a first plurality of vias, the post is a first post, the inner plate is a first inner plate, and wherein the apparatus further comprises:
a second plurality of vias comprising conductive material extending from the lower plate to the upper plate;
a second post comprising conductive material extending from the lower plate and towards the upper plate; and
a second inner plate comprising conductive material above and in contact with the second post, wherein the second post and the second inner plate are separated from the upper plate by the dielectric material, wherein the second plurality of vias are arranged to at least in part wrap around the second post.

13. The apparatus of claim 1, wherein:
the upper plate has an opening that is at least in part above the inner plate.

14. The apparatus of claim 1, wherein:
the apparatus comprises a cavity defined by (i) the lower plate forming a lower surface of the cavity, (ii) the upper plate forming an upper surface of the cavity, and (iii) the plurality of vias forming walls of the cavity, with the post and the inner plate within the cavity; and
upper plate has one or more openings that are above the cavity, but not above the post or the inner plate.

15. A method of tuning a filter structure comprising at least a first resonator and a second resonator, comprising:
forming the filter structure that comprises an upper plate and a lower plate that are common to both first and second resonators, wherein the first resonator further comprises (i) a first post extending from the lower plate towards the upper plate, (ii) a first inner plate above the first post, and (iii) a first plurality of vias extending from the lower plate to the upper plate and arranged at least in part around the first post, and wherein the second resonator further comprises (i) a second post extending from the lower plate towards the upper plate, (ii) a second inner plate above the second post, and (iii) a second plurality of vias extending from the lower plate to the upper plate and arranged at least in part around the second post;
forming a first opening within the upper plate and above the first post; and
forming a second opening within a section of the upper plate, the section of the upper plate between the second post and the second plurality of vias.

16. The method of claim 15, wherein forming the first opening comprises:
determining that the first resonator has a first resonance frequency that is lower than a first target frequency; and
in response to determining that the first resonance frequency is lower than the first target frequency, forming the first opening within the upper plate and above the first post.

17. The method of claim 16, wherein forming the first opening comprises:
prior to forming the first opening, calculating a target diameter of the first opening, based on a difference between the first resonance frequency and the first target frequency; and
forming the first opening having the target diameter.

18. The method of claim 16, wherein forming the second opening comprises:
determining that the second resonator has a second resonance frequency that is higher than a second target frequency; and
in response to determining that the second resonance frequency is higher than the second target frequency, forming the second opening within the section of the upper plate that is between the second post and the second plurality of vias.

19. A filter comprising at least a first resonator and a second resonator, the filter comprising:
an upper plate and a lower plate that are common to both first and second resonators;
wherein the first resonator further comprises (i) a first post extending from the lower plate towards the upper plate, (ii) a first inner plate above the first post, and (iii) a first plurality of vias extending from the lower plate to the upper plate and arranged at least in part around the first post; and
wherein the second resonator further comprises (i) a second post extending from the lower plate towards the upper plate, (ii) a second inner plate above the second post, and (iii) a second plurality of vias extending from the lower plate to the upper plate and arranged at least in part around the second post.

20. The filter of claim 19, wherein:
the upper plate comprises a first opening above the first post, and
the upper plate comprises a second opening within a section of the upper plate that is between the second post and the second plurality of vias.
